(19) United States
(12) Patent Application Publication
(10) Pub. No.: US 2026/0129218 A1
(43) Pub. Date: May 7, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Kai ZHANG, Los Angeles, CA (US); Li ZHANG, Los Angeles, CA (US)

(21) Appl. No.: 19/437,106

(22) Filed: Dec. 30, 2025

Related U.S. Application Data
(63) Continuation of application No. PCT/CN2024/101748, filed on Jun. 26, 2024.

(30) Foreign Application Priority Data
Jun. 30, 2023 (WO) PCT/CN2023/105010

(51) Int. Cl. H04N 19/196; H04N 19/105; H04N 19/176; H04N 19/513; H04N 19/70

(52) U.S. Cl. CPC H04N 19/196; H04N 19/105; H04N 19/176; H04N 19/521; H04N 19/70

(57) ABSTRACT

Embodiments of the disclosure provide a solution for video processing. A method for video processing is proposed. The method includes: determining, for a conversion between a video unit of a video and a bitstream of the video, that one or more parameters of a cross-component residual model (CCRM) of the video unit is inherited from a previous CCRM coded block; and performing the conversion based on the CCRM.

### CROSS-REFERENCE TO RELATED APPLICATIONS

This application is a continuation of International Application No. PCT/CN2024/101748, filed on Jun. 26, 2024, which claims the benefit of International Application No. PCT/CN2023/105010, filed on Jun. 30, 2023. The entire contents of these applications are hereby incorporated by reference in their entireties.

### FIELDS

Embodiments of the present disclosure relates generally to video processing techniques, and more particularly, to cross component model for residual coding.

### BACKGROUND

In nowadays, digital video capabilities are being applied in various aspects of peoples lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, there are several issues in conventional video coding, which is undesirable. Therefore, the coding gain of conventional video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, that one or more parameters of a cross-component residual model (CCRM) of the video unit is inherited from a previous CCRM coded block; and performing the conversion based on the CCRM. In this way, it can improving coding efficiency and coding performance.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining that one or more parameters of a cross-component residual model (CCRM) of a video unit of the video is inherited from a previous CCRM coded block; and generating the bitstream of the video unit based on the CCRM.

In a fifth aspect, a method for storing a bitstream of a video is proposed. The method comprises: determining that one or more parameters of a cross-component residual model (CCRM) of a video unit of the video is inherited from a previous CCRM coded block: generating the bitstream of the video unit based on the CCRM; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an illustration of the effect of the slope adjustment parameter “u” where model created with the current CCLM is shown on the left and model updated as proposed is shown on the right;

FIG. 5 illustrates neighboring blocks (L, A, BL, AR, AL) used in the derivation of a general MPM list;

FIG. 6 illustrates neighboring reconstructed samples used for DIMD chroma mode;

FIG. 7 illustrates intra template matching search area used;

FIG. 8 illustrates the use of IntraTMP block vector for IBC block;

FIG. 9 illustrates the division method for angular modes;

FIG. 10 illustrates extended MRL candidate list;

FIG. 11 illustrates an illustration of the template area;

FIG. 12 illustrates spatial part of the convolutional filter;

FIG. 13 illustrates reference area (with its paddings) used to derive the filter coefficients;

FIG. 14 illustrates four Sobel based gradient patterns for GLM;

FIG. 15 illustrates spatial GPM candidates;

FIG. 16 illustrates an GPM template;

FIG. 17 illustrates an GPM blending;

FIG. 18 illustrates possible positions of candidate regions;

FIG. 19 illustrates positions of the adjacent spatial candidates;

FIG. 20 illustrates a transform selection process for directional planar modes;

FIG. 21 illustrates luma blocks used to derive direct block vector;

FIG. 22 illustrates the defined three types of reconstructed areas include thirteen columns or rows of reconstructed pixels;

FIG. 23 illustrates the defined three types of filter shapes have fifteen inputs and generate one output;

FIG. 24 illustrates examples of prediction for different positions in the current block;

FIG. 25 illustrates the proposed method on the decoder;

FIG. 26 illustrates luma samples L0, . . . , L5 in relation to the chroma sample C (shown in a half-pel luma grid);

FIG. 27 shows luma samples L0, . . . , L5 in relation to chroma sample C;

FIG. 28 shows an example of current template and reference template involved for current inter block's CCRM coding;

FIG. 29 shows an example of current template and reference template involved for current IBC block's CCRM coding;

FIG. 30 illustrates a flowchart of a method for video processing in accordance with embodiments of the present disclosure; and

FIG. 31 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

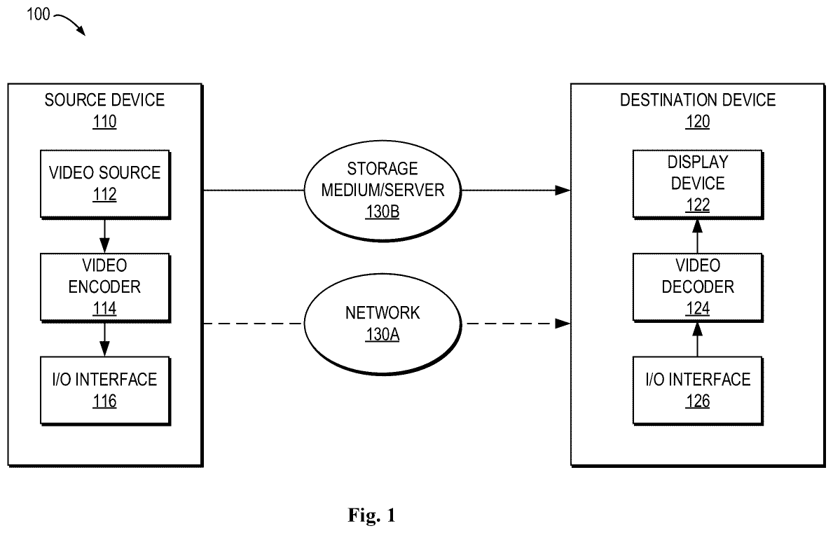

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard. Versatile Video Coding (VVC) standard and other current and/or further standards.

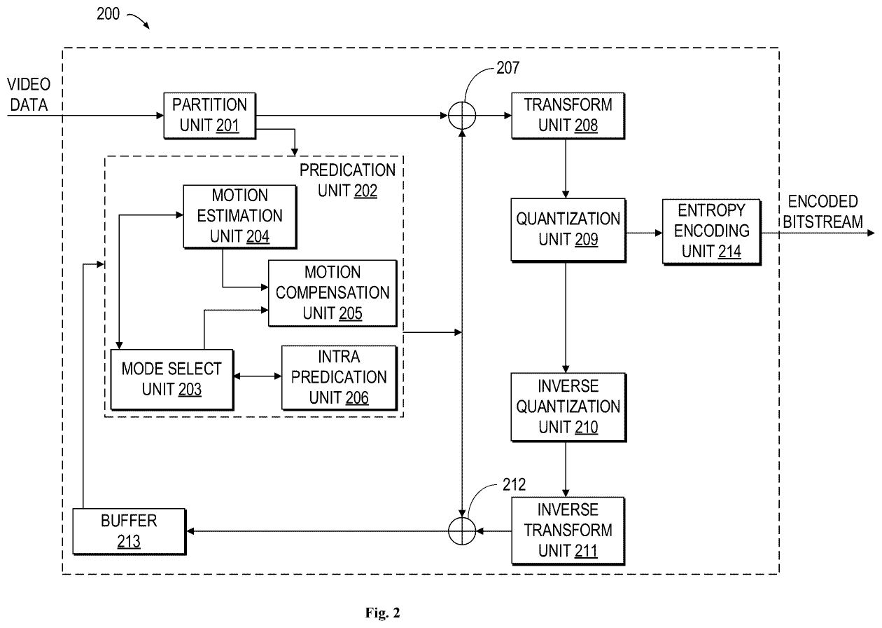

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects. “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

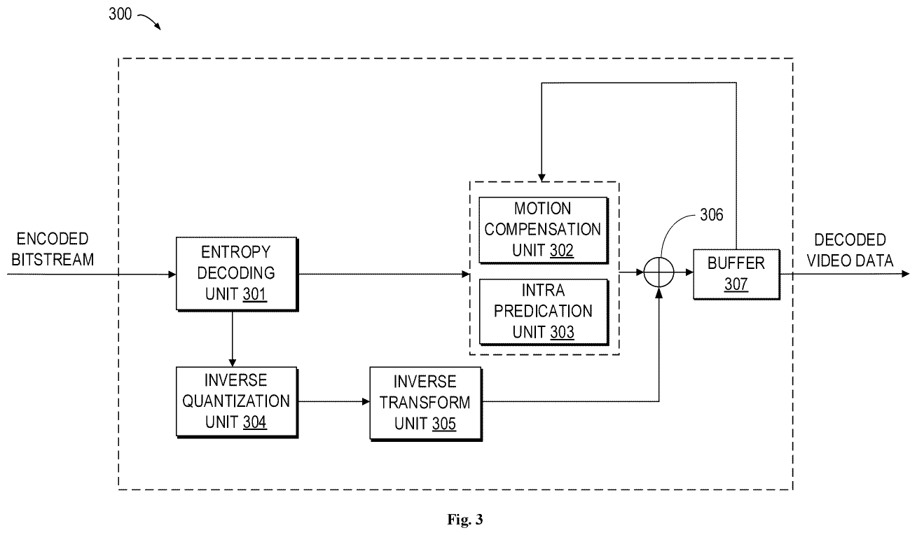

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks. e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1 Brief Summary

The present disclosure is related to video coding technologies. Specifically, it is about chroma prediction in image/video coding. It may be applied to the existing video coding standard like HEVC, VVC, and etc. It may be also applicable to future video coding standards or video codec.

### 2 Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1 Intra Prediction

In intra prediction the smallest chroma intra prediction unit (SCIPU) constraint in VVC is removed. In addition, the VPDU constraint for reducing CCLM prediction latency is also removed.

### 2.1.1 Multi-Model LM (MMLM)

CCLM included in VVC is extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

### 2.1.1.1 Slope Adjustment of CCLM

CCLM uses a model with 2 parameters to map luma values to chroma values. The slope parameter “a” and the bias parameter “b” define the mapping as follows:

$$chromaVal = a * lumaVal + b$$

An adjustment “u” to the slope parameter is signaled to update the model to the following form:

$$chromaVal = a ’ * lumaVal + b ’$$

where

$$a ’ = a + u$$

$$b ’ = b - u * {y}_{r} .$$

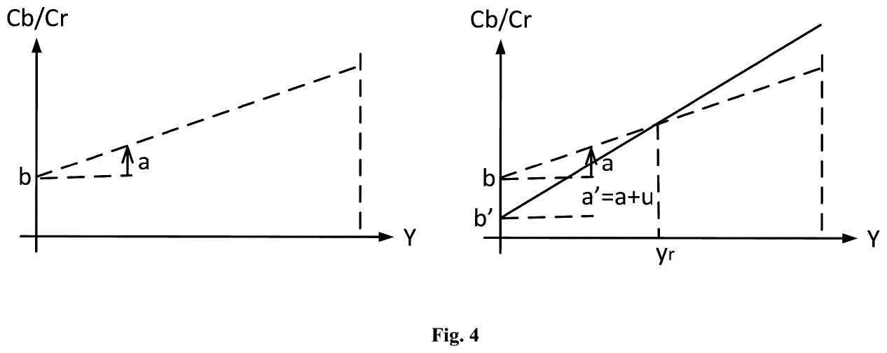

With this selection the mapping function is tilted or rotated around the point with luminance value yᵣ. The average of the reference luma samples used in the model creation as yᵣ in order to provide a meaningful modification to the model. Picture below illustrates the process. FIG. 4 illustrates an illustration of the effect of the slope adjustment parameter “u”. Left: model created with the current CCLM. Right: model updated as proposed.

FIG. 4 illustrates the effect of the slope adjustment parameter “u”. Left: model created with the current CCLM. Right: model updated as proposed.

### Implementation

Slope adjustment parameter is provided as an integer between −4 and 4, inclusive, and signaled in the bitstream. The unit of the slope adjustment parameter is ⅛^{th} of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 2.1.2 Gradient PDPC

In VVC, for a few scenarios, PDPC may not be applied due to the unavailability of the secondary reference samples. In these cases, a gradient based PDPC, extended from horizontal/vertical mode, is applied. The PDPC weights (wT/wL) and nScale parameter for determining the decay in PDPC weights with respect to the distance from left/top boundary are set equal to corresponding parameters in horizontal/vertical mode, respectively. When the secondary reference sample is at a fractional sample position, bilinear interpolation is applied.

### 2.1.3 Secondary MPM

Secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks, the directional modes with added offset from the first two available directional modes of neighbouring blocks, and the default modes.

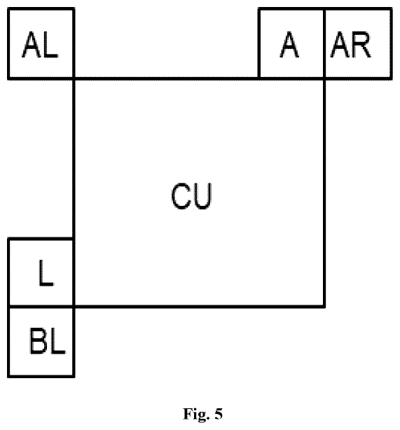

If a CU block is vertically oriented, the order of neighbouring blocks is A, L, BL, AR, AL: otherwise, it is L, A, BL, AR, AL. FIG. 5 illustrates neighboring blocks (L, A, BL, AR, AL) used in the derivation of a general MPM list.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.1.4 Reference Sample Interpolation and Smoothing for Intra-Prediction

The 4-tap cubic interpolation is replaced with a 6-tap cubic interpolation filter, for the derivation of predicted samples from the reference samples.

For reference sample filtering, a 6-tap gaussian filter is applied for larger blocks (W>=32 and H>=32), existing VVC 4-tap gaussian interpolation filter is applied otherwise. The extended intra reference samples are derived using the 4-tap interpolation filter instead of the nearest neighbor rounding.

### 2.1.5 Decoder Side Intra Mode Derivation (DIMD)

When DIMD is applied, two intra modes are derived from the reconstructed neighbor samples, and those two predictors are combined with the planar mode predictor with the weights derived from the gradients. The division operations in weight derivation are performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$x = Floor ( Log 2 ( Gx ) )$$

$$normDiff = ( ( Gx << 4 ) >> x ) \& 15$$

$$x += ( 3 + ( normDiff != 0 ) ? 1 : 0 )$$

$$Orient = ( Gy * ( DivSigTable [ normDiff ] \vert 8 ) + ( 1 << ( x - 1 ) ) ) >> x$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 2.1.5.1 DIMD Chroma Mode

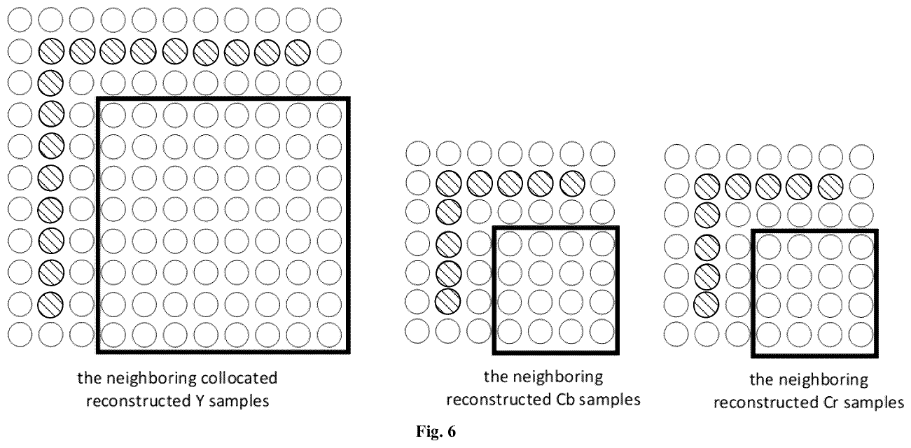

The DIMD chroma mode uses the DIMD derivation method to derive the chroma intra prediction mode of the current block based on the neighboring reconstructed Y, Cb and Cr samples in the second neighboring row and column. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block. FIG. 6 illustrates neighboring reconstructed samples used for DIMD chroma mode.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

### 2.1.6 Fusion of Chroma Intra Prediction Modes

The DM mode and the four default modes can be fused with the MMLM_LT mode as follows:

$$pred = ( w 0 * pred 0 + w 1 * pred 1 + ( 1 << ( shift - 1 ) ) ) >> shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}: when the above and left adjacent blocks are both coded with non-LM modes, {w0, w1}={3, 1}: otherwise, {w0, w1}={2, 2}.

For the syntax design, if a non-LM mode is selected, one flag is signaled to indicate whether the fusion is applied. This method only applies to I slices.

### 2.1.7 Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

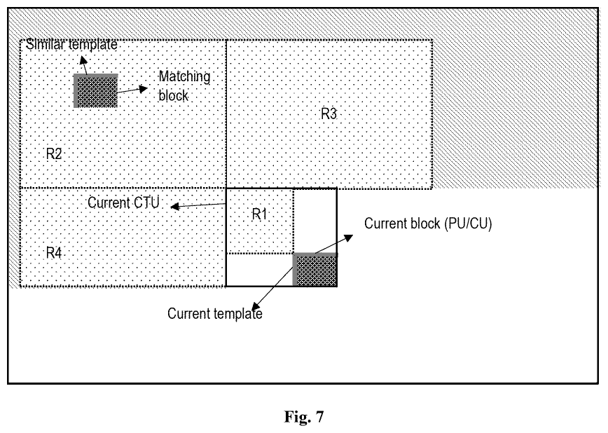

The prediction signal is generated by matching the L-shaped causal neighbor of the current block with another block in a predefined search area in FIG. 7 consisting of:
R1: current CTU
R2: top-left CTU
R3: above CTU
R4: left CTU

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlKW, BlkH) to have a fixed number of SAD comparisons per pixel. That is:

$$SearchRange\_w = a * BlkW$$

$$SearchRange\_h = a * BlkH$$

where ‘a’ is a constant that controls the gain/complexity trade-off. In practice, ‘a’ is equal to 5. FIG. 7 illustrates intra template matching search area used.

To speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min (BlkW, BlkH)/2.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.1.7.1 IntraTMP Derived Block Vector Candidates for IBC

In this method block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

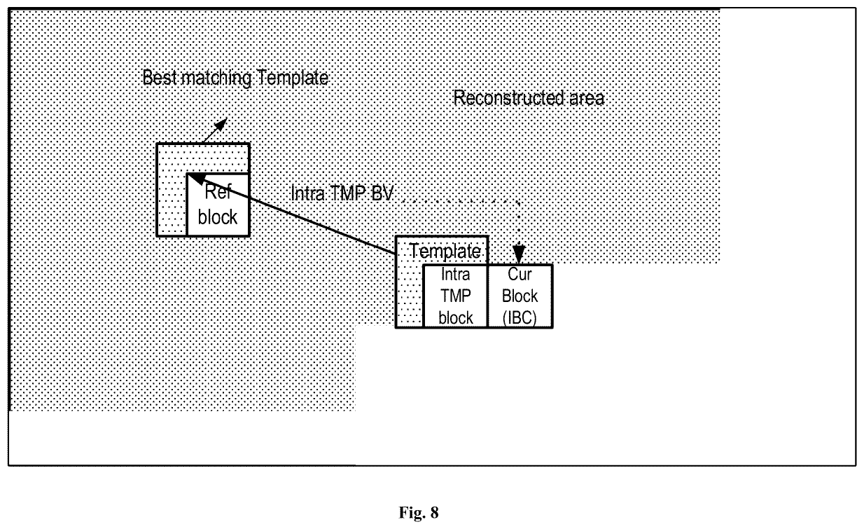

IntraTMP block vector is stored in the IBC block vector buffer and, the current IBC block can use both IBC BV and IntraTMP BV of neighbouring blocks as BV candidate for IBC BV candidate list as shown in FIG. 8.

IntraTMP block vectors are added to IBC block vector candidate list as spatial candidates.

### 2.1.8 Fusion for Template-Based Intra Mode Derivation (TIMD)

For each intra prediction mode in MPMs, the SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < * costMode 1$$

If this condition is true, the fusion is applied, otherwise the only model is used.

Weights of the modes are computed from their SATD costs as follows:

$$weight 1 = costMode 2 / ( costMode 1 + costMode 2 ) ;$$

$$weight 2 = 1 - weight 1.$$

The division operations are conducted using the same lookup table (LUT) based integerization scheme used by the CCLM.

### 2.1.9 Intra Prediction Fusion

This intra prediction method derives predicted samples as a weighted combination of multiple predictors generated from different reference lines. In this process multiple intra predictors are generated and then fused by weighted averaging. The process of deriving the predictors to be used in the fusion process is described as follows:
For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.
For TIMD mode with blending, pₗᵢₙₑ is used for the first mode (w₀=1, w₁=0) and pₗᵢₙₑ₊₁ is used for the second mode (w₀=0, w₁=1).
For DIMD mode with blending, the number of predictors selected for a weighted average is increased from 3 to 6.

Intra prediction fusion method is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.

2.1.10 Combination of CHIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

In addition, it is also proposed to modify the weights (wIntra, wInter) for the two tests if the derived intra prediction mode is an angular mode. For near-horizontal modes (2<=angular mode index<34), the current block is vertically divided: for near-vertical modes (34<=angular mode index<=66), the current block is horizontally divided.

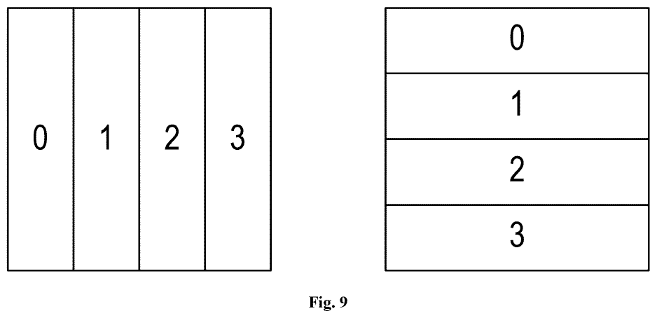

The (wIntra, wInter) for different sub-blocks are shown in FIG. 9.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.1.11 Extended Multiple Reference Line (MRL) List

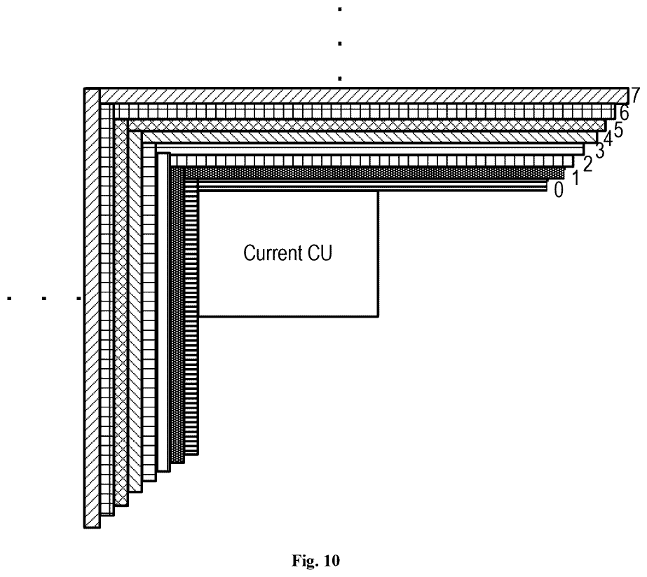

MRL list in VVC is extended to include more reference lines for intra prediction. The extended reference line list consists of line indices {1, 3, 5, 7, 12}. For template-based intra mode derivation (TIMD), instead of the full MRL candidate list, only the first two reference line candidates, i.e., {1, 3}, are used. FIG. 10 illustrates extended MRL candidate list.

### 2.1.12 Template-Based Multiple Reference Line Intra Prediction

Template-based multiple reference line intra prediction (TMRL) mode combines reference line and prediction mode together and uses a template matching method to construct a list of candidate combinations. An index to the candidate combination list is coded to indicate which reference line and prediction mode is used in coding the current block. The regular multiple reference line (MRL) for the non-TIMD part is replaced by TMRL mode.

The TMRL mode extends reference line candidate list and the intra-prediction-mode candidate list. The extended reference line candidate list is {1, 3, 5, 7, 12}. The restriction on the top CTU row is unchanged. The size of the intra-prediction-mode candidate list is 10. The construction of the intra-prediction-mode candidate list is similar to MPM except the PLANAR mode is excluded from the intra-prediction-mode candidate list, DC mode is added after 5 neighboring PUs' modes and DIMD modes if its not included and the angular modes with delta angles from ±1 to ±4 (compared the existing angular modes in the intra-prediction-mode candidate list) are added.

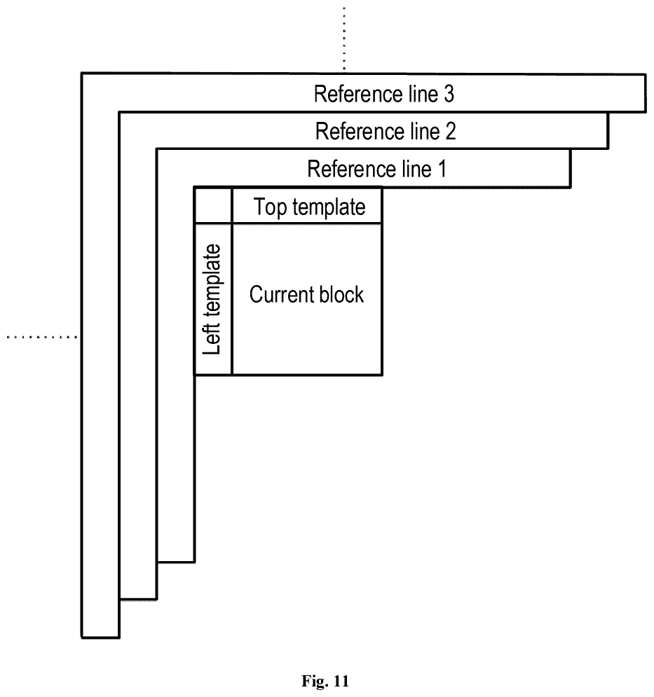

The TMRL candidate is constructed as follows. There are 5×10=50 combinations of the extended reference line and the allowed intra-prediction modes for a block. Since the extended reference line starts from reference line 1, the area covered by reference line 0 is used for template matching. The SAD costs over the template area (see FIG. 11) are calculated between the predictions (generated by 50 combinations) and the reconstructions. The 20 combinations with the least SAD cost are selected in an ascending order to form the TMRL candidate list.

For TMR signalling instead of coding the reference line and the intra mode directly, an index to the TMRL candidate list is coded to indicate which combination of reference line and prediction mode is used for coding the current block.

### 2.1.13 Convolutional Cross-Component Intra Prediction Model

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.1.13.1 Convolutional Filter

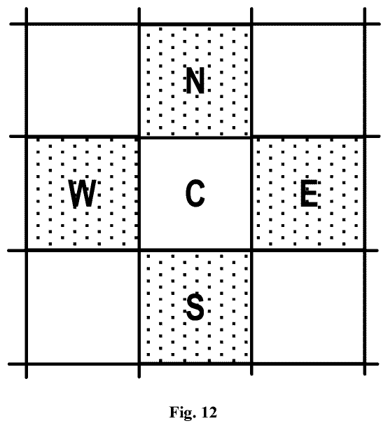

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/cast (E) neighbors as illustrated below. FIG. 12 illustrates spatial part of the convolutional filter.

The nonlinear term P is represented as power of two of the center luma sample C and scaled to the sample value range of the content:

$$P = ( C * C + mid Val ) >> bitDepth$$

That is, for 10-bit content it is calculated as:

$$P = ( C * C + 5 \; 12 ) >> 10$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

### 2.1.13.2 Calculation of Filter Coefficients

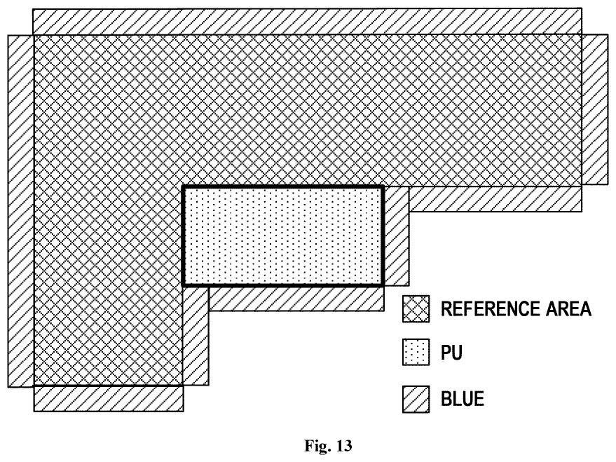

The filter coefficients cᵢ are calculated by minimising MSE between predicted and reconstructed chroma samples in the reference area. FIG. 13 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$${C}^{′} = C - offsetLuma$$

$${N}^{′} = N - offsetLuma$$

$${S}^{′} = S - offsetLuma$$

$${E}^{′} = E - offsetLuma$$

$${W}^{′} = W - offsetLuma$$

$${P}^{′} = nonLinear ( {C}^{′} )$$

$$B = midValue = 1 << ( bitDepth - 1 )$$

and the chroma value is predicted using the following equation, where offsetChroma is equal to offsetCr and offsetCb for Cr and Cb components, respectively:

$$predChromaVal = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} B + offsetChroma .$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operation are replaced with multiplication (with a scale factor) and shift operation, where scale factor and number of shifts are calculated based on denominator similar to the method used in calculation of CCLM parameters.

### 2.1.13.3 Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

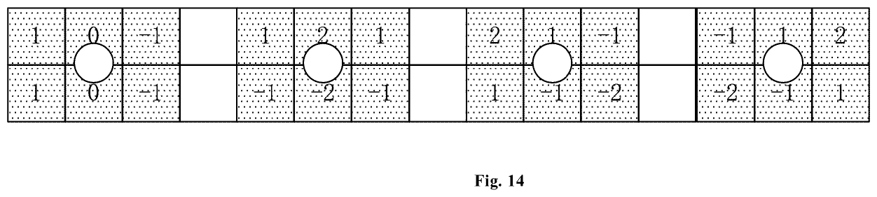

For signaling, when the CCLM mode is enabled to the current CU, one flag is signaled to indicate whether GLM is enabled for both Cb and Cr components: if the GLM is enabled, another flag is signaled to indicate which of the two GLM modes is selected and one syntax element is further signaled to select one of 4 gradient filters for the gradient calculation. Four gradient filters are enabled for the GLM, as illustrated in FIG. 14.

### 2.1.13.4 Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

### 2.1.14 Spatial Geometric Partitioning Mode (SGPM)

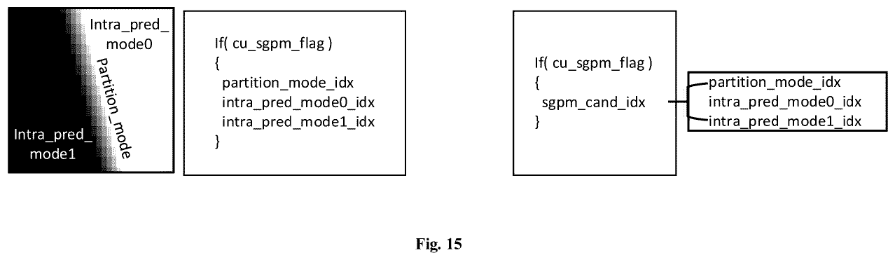

SGPM is an intra mode that resembles the inter coding tool of GPM, where the two prediction parts are generated from intra predicted process. In this mode, a candidate list is built with each entry containing one partition split and two intra prediction modes as shown in FIG. 15. 26 partition modes and 3 of intra prediction modes are used to form the combinations, the length of the candidate list is set equal to 16. The selected candidate index is signalled.

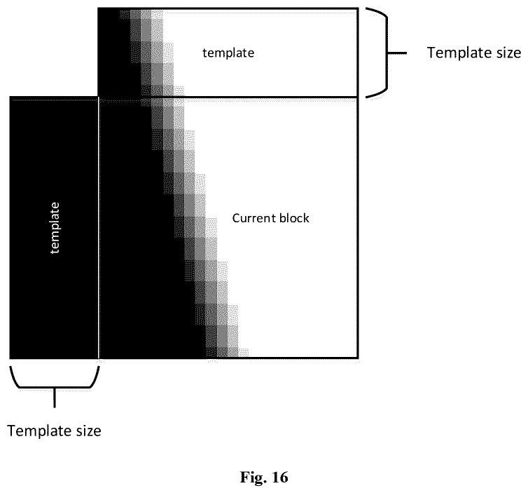

The list is reordered using template (FIG. 16) where SAD between the prediction and reconstruction of the template is used for ordering. The template size is fixed to 1.

For each partition mode, an IPM list is derived for each part using the same intra-inter GPM list derivation. The IPM list size is set to 3. In the list, TIMD derived mode is replaced by 2 derived modes with horizontal and vertical orientations.

The SGPM mode is applied with a restricted blocks size: 4<=width<=64, 4<=height<=64, width<height*8, height<width*8, width*height>=32.

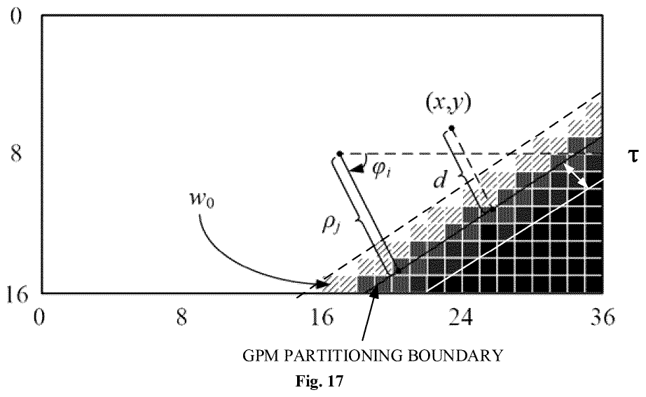

Adaptive blending is also used for spatial GPM, where blending depth t shown in FIG. 17 is derived as follows:

| | |
|---|---|
| \| | If min(width, height)==4, ½ τ is selected. |
| ⊏ | else if min(width, height)==8, τ is selected. |
| \| | else if min(width, height)==16, 2 τ is selected. |
| ⊏ | else if min(width, height)==32, 4 τ is selected. |
| \| | else, 8 τ is selected. |

### 2.1.15 Non-Local Cross-Component Prediction

Cross-component prediction (CCP) including CCLM, CCCM and their variants are adopted in ECM to exploit the cross-component correlation. With CCLM or CCCM, Training samples are always adjacent to the current block. However, the cross-component relationship of the current block may be more correlated to that of a non-local region.

Methods of non-local cross-component prediction are proposed to boost CCP by taking more advantage from non-local regions.

### Method #1:

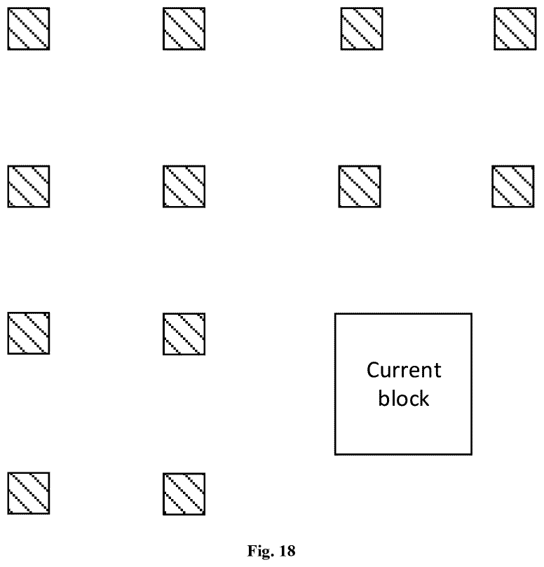

Non-adjacent cross-component prediction (NA-CCP) mode is proposed. With NA-CCP mode, Samples in regions non-adjacent to the current block can be used to derive a CCCM model for the current block. A candidate region list with 6 candidates is constructed by checking potential 8×8 regions in order. If a checked region is available, it is put into the candidate region list. The top-left positions of the potential 8×8 regions are predetermined as {(−xStep, 0), (0, −yStep), (xStep, −yStep), (−xStep, yStep), (−xStep, −yStep), (−2*xStep, 0), (0, −2*yStep), (−2*xStep, 2*yStep), (2*xStep, −2*yStep), (−2*xStep, yStep), (xStep, −2*yStep), (−2*xStep, −yStep), (−xStep, −2*yStep), (−2*xStep, −2*yStep), (−xStep/2, 0), (0), −yStep/2), (xStep/2, −yStep/2), (−xStep/2, yStep/2), (−xStep/2, −yStep/2)}, where xStep=Max(width, 16), yStep=Max(height, 16). FIG. 18 shows some possible positions of candidate regions.

A flag is signaled to indicate whether NA-CCP is applied to a chroma block. If NA-CCP is applied, an index is signaled to indicate which candidate in the candidate region list is used to derive the CCCM model.

### Method #2:

History-based cross-component prediction (H-CCP) mode is proposed. With H-CCP, a H-CCLM table and a H-CCCM table are maintained similar to the HMVP table. After decoding a CCLM or CCCM coded block, the corresponding table is updated. In the implementation of H-CCP, the size of either H-CCLM table or H-CCCM table is 6. If the current block is coded with CCLM or CCCM mode, a flag is signaled to indicate whether H-CCP is applied. If H-CCP is used, an index is further signaled to indicate which candidate model in the H-CCLM table or H-CCCM table is selected.

### 2.1.16 Cross-Component Merge Mode for Chroma Intra Coding

Cross-component prediction (CCP) including cross-component linear model (CCLM), convolutional cross-component model (CCCM), and gradient linear model (GLM) are adopted in ECM to exploit the cross-component correlation. A cross-component merge (CCMerge) mode is proposed as a new CCP mode. Cross component model parameters of the current chroma block coded with CCMerge can be inherited from a neighboring block coded with CCP. Through CCMerge, CCP can be more efficient with less signalling overhead.

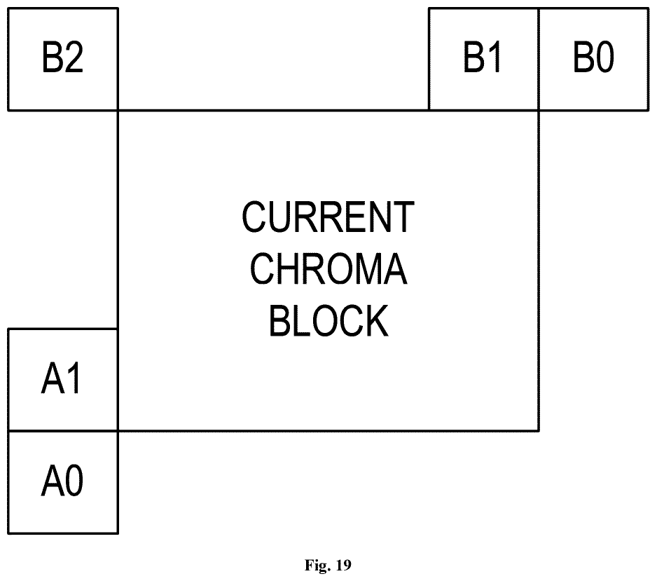

In CCMerge, final cross-component model parameters of the current chroma block can be inherited from its spatial adjacent and non-adjacent neighbors, or default models. A list is created, which includes CCP models from the spatial adjacent and non-adjacent neighbors coded in CCLM, MMLM, CCCM, GLM, chroma fusion, and CCMerge modes. After including neighboring CCP models, default models are further included to fill the remaining empty positions in the list. To avoid including redundant CCP models in the list, pruning operations are applied. More details are described as follows. FIG. 19 illustrates positions of the adjacent spatial candidates.

### Spatial Adjacent Neighboring Candidates

Positions of the spatial adjacent candidates are shown in FIG. 19. Spatial candidates are included in the following order: B1→A1→B0→A0→B2.

### Spatial Non-Adjacent Neighboring Candidates

Spatial non-adjacent neighboring candidates are considered after all spatial adjacent neighbors are checked. In the current ECM design, in inter merge mode, two sets of spatial non-adjacent neighboring candidates are obtained. In the proposed method, positions and inclusion order of the spatial non-adjacent neighboring candidates from the first set are used.

CCLM Candidates with Default Scaling Parameters

CCLM candidates with default scaling parameters are considered after including the spatial adjacent and non-adjacent candidates if the list is not full. The default scaling parameters are {0, ⅛, −⅛, 2/8, − 2/8, ⅜}, and the offset parameter is derived according to the selected default scaling parameter, average neighboring reconstructed luma sample value (Yavg), and average neighboring reconstructed Cb/Cr sample value (Cavg).

### 2.1.16.1 Merging Model Candidates

When merging a CCLM candidate, only the scaling parameter is inherited. The offset parameter is derived by using the inherited scaling parameter, Yavg and Cavg.

When merging a MMLM candidate, the scaling parameters and the classification threshold are inherited. The offset parameter in each class is derived according to the inherited classification threshold and the Yavg and Cavg in each class. If no neighboring reconstructed samples are available in a class, the offset parameter is directly inherited from the candidate.

When merging a CCCM candidate, all convolution parameters, offsets (i.e., offsetLuma, offsetCb, and offsetCr), and the classification threshold are inherited.

When merging a GLM candidate, if the GLM candidate is 3-parameter GLM mode, all the gradient pattern index and model parameters are inherited: otherwise, if the GLM candidate is the 2-parameter GLM mode, the offset parameter is derived by using the inherited scaling parameter, Yavg, and Cavg.

When merging a chroma fusion candidate, the derived MMLM parameters are inherited and used as merging MMLM candidate.

For a CCMerge block, if its merging candidate mode is CCLM, MMLM, CCCM, or GLM, the merging candidate mode is stored as the propagation mode of the current chroma block: otherwise, if its merging candidate mode is chroma fusion, the propagation mode is set to MMLM. When merging a CCMerge candidate, how to inherit or derive the CCP parameters depends on the propagation mode of the CCMerge candidate, as described in the above five paragraphs.

### 2.1.16.2 Signaling

An additional flag is signalled indicating whether CCMerge is used or not after cclm_mode_flag syntax element. If CCMerge is used, a candidate index is additionally signalled. The signalled candidate index is shared for Cb/Cr color components. Currently, the maximum number of allowed candidates is set to 6 as default. If maximum number of allowed candidates is modified to 1, candidate index does not need to be signalled. Each bin of candidate index is context coded with a separate context.

### 2.1.17 Directional Planar Mode

Two additional planar modes where only the horizontal interpolation or only the vertical interpolation are used to obtain the predicted samples.

For planar horizontal mode, only the horizontal linear interpolation is performed based on the left reference sample and the top-right reference sample to predict the current sample as:

$$pred ( x , y ) = ( ( W - 1 - x ) * r e c ( - 1 , y ) + ( x + 1 ) * r e c ( W , - 1 ) + ( W ≫ 1 ) ) ≫ {log}_{2} ( W )$$

For planar vertical mode, only the vertical linear interpolation is performed based on the above reference sample and the bottom-left reference sample to predict the current sample as:

$$pred ( x , y ) = ( ( H - 1 - y ) * r e c ( x , - 1 ) + ( y + 1 ) * r e c ( - 1 , H ) + ( H ≫ 1 ) ) ≫ {log}_{2} ( H )$$

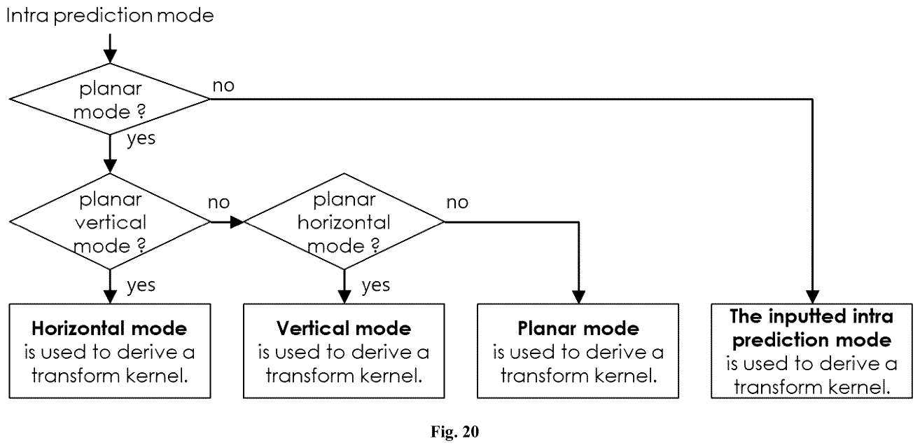

The transform kernel selection for planar horizontal and planar vertical mode is shown in FIG. 20. If an intra prediction mode of a current block is the planar vertical mode, the horizontal intra prediction mode is used to derive a transform kernel in MTS set and LFNST set. Also, if an intra prediction mode of a current block is the planar horizontal mode, the vertical intra prediction mode is used to derive a transform kernel in MTS set and LFNST set.

### 2.1.18 Direct Block Vector for Chroma Block

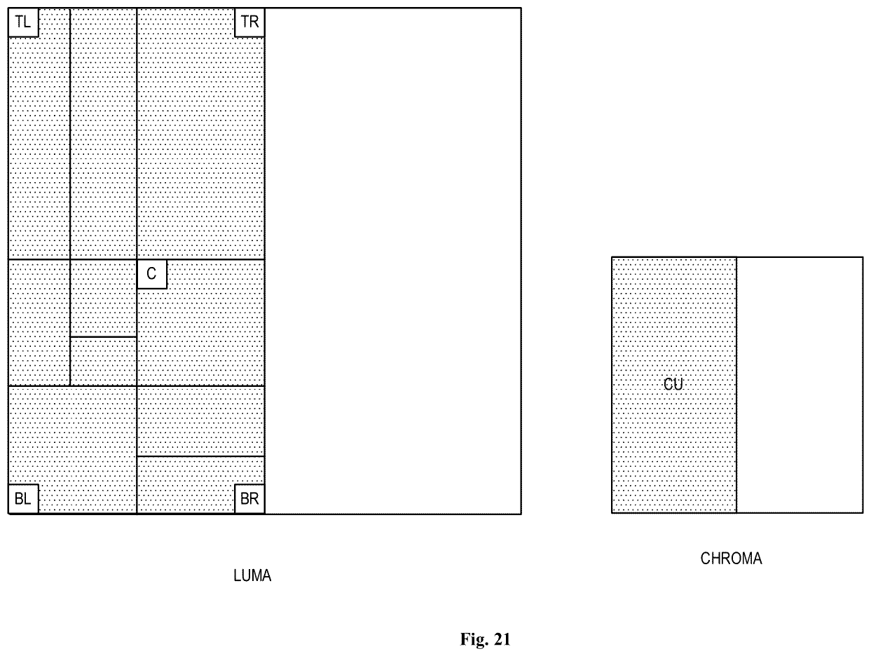

The direct block vector is used for chroma block in dual tree slices. When chroma dual tree is activated, a flag is signaled to indicate whether a chroma block is coded using IBC mode. If one of the luma blocks in five locations shown in FIG. 21 is coded with IBC or intraTMP mode, its block vector is scaled and is used as block vector for the chroma block. Template matching is used to perform block vector scaling.

### 2.1.19 an Extrapolation Filter-Based Intra Prediction Mode (EFI Mode)

The proposed extrapolation filter-based intra prediction is processed in two steps. First, the extrapolation filter coefficients are obtained from the neighboring reconstructed pixels of the current block with a pre-determined template. Second, the extrapolation generates a predicted value position by position from top-left to bottom-right within the current block.

### 2.1.19.1 Searching Mean, Min, and Max Value

Similar to CCCM mode, a mean value should be removed when feeding the inputs to the EIP filter. The value of the DC mode for the current block is used as a mean value for EIP prediction. The min and max value are searched from reconstructed pixels in the reconstructed area with thirteen columns and thirteen rows.

### 2.1.19.2 Calculation of Filter Coefficients

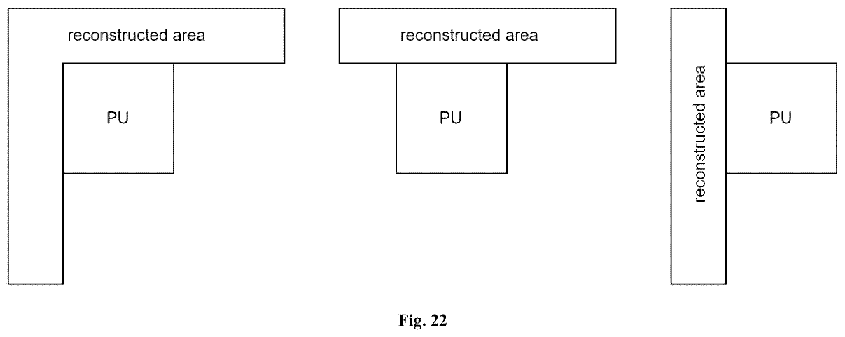

Three types of reconstructed areas and three filter shapes are proposed, as shown in FIG. 22. The defined three types of reconstructed areas include thirteen columns or rows of reconstructed pixels. When the current block uses the proposed EIP mode for prediction, the decoder decodes the relevant syntax elements to determine the selected type of reconstructed area and filter shape for the current block.

FIG. 22 illustrates the defined three types of reconstructed areas include thirteen columns or rows of reconstructed pixels.

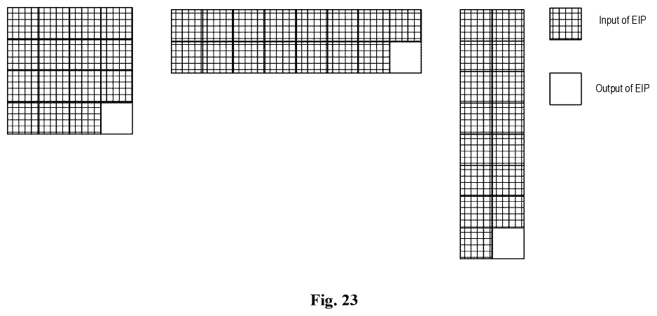

FIG. 23 illustrates the defined three types of filter shapes have fifteen inputs and generate one output.

The selected filter slides in the selected reconstructed area with a one-pixel step to collect input samples and output samples of EIP. The auto-correlation matrix and cross-correlation vector are constructed while removing the mean value from input samples and output samples. Then, the EIP coefficients are obtained by the same method in CCCM.

### 2.1.19.3 Prediction of Current Block

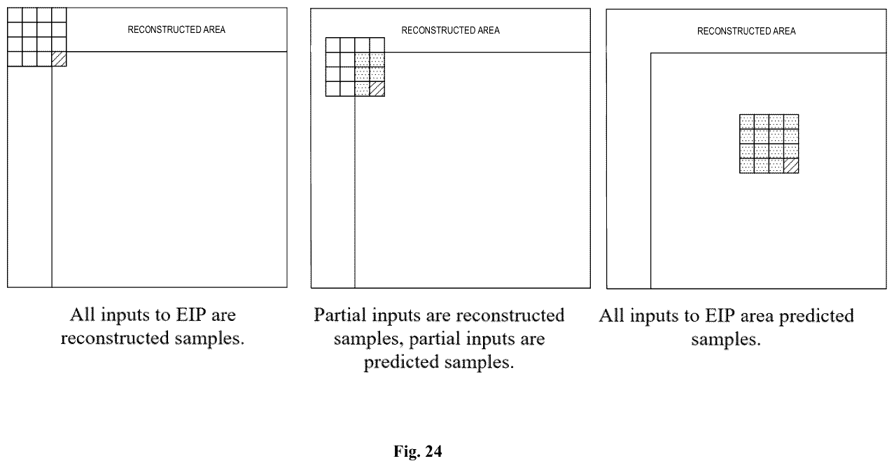

The EIP mode makes predictions for the current block position by position, as shown in FIG. 24.

For the position located at top-left of the current block, the inputs to the EIP filter are reconstructed samples.

For the positions located along the boundaries of the current block, partial inputs to the EIP filter are reference samples, and partial inputs to the EIP filter are previously predicted samples.

For other positions in the current block, the inputs to the EIP filter are previously predicted samples.

To reduce the prediction error, the searched min and max values are applied to restrict the output range of each predicted value,

$$p r e {d}_{( x , y )} = clip ( min , max , ( {\sum }_{i = 0}^{n} ( {c}_{i} \times ( {t}_{( x - x o f f set , y - yoffset )} - mean ) ) ) + mean )$$

pred_{(x,y)} is the predicted value at (x, y) in the current block,
min, max are searched min and max values from the thirteen reconstructed columns and rows,
cᵢ is the i^{th} coefficient of the derived EIP filter,
t_{(x-xoffset,y-yoffset)} is reconstructed or predicted value used for the current position's prediction,
mean is a value calculated by the DC prediction mode.

### 2.2 Cross-Component Residual Model (CCRM) for Inter Prediction

### 2.2.1 Introduction

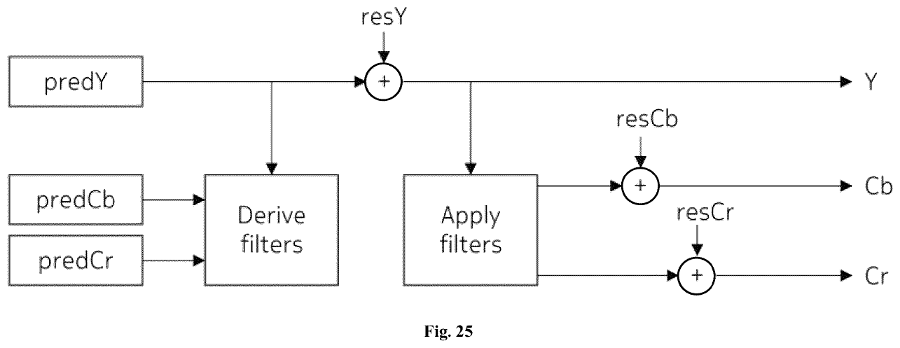

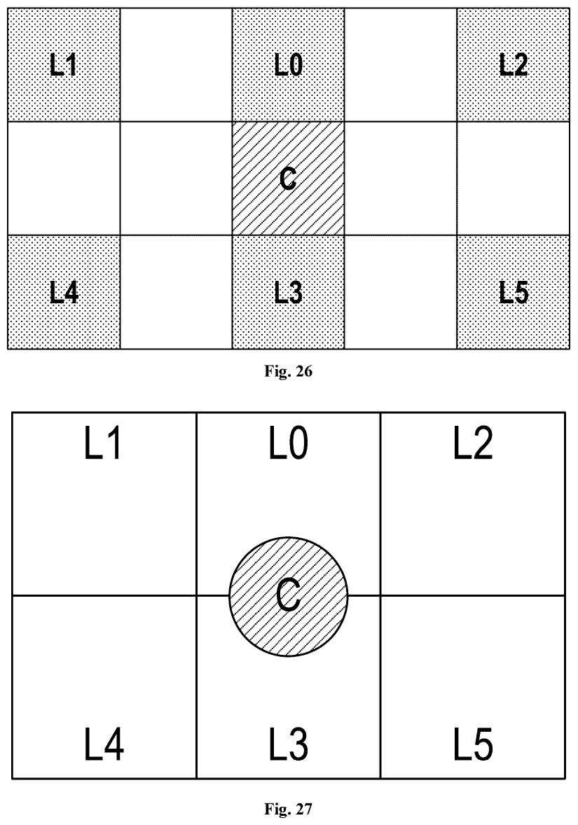

It is proposed to apply cross-component residual model (CCRM) to predict chroma samples from reconstructed luma samples when the block uses inter prediction or intra block copy (IBC). FIG. 25 illustrates the decoder side of the method. The cross-component filters are derived using the prediction signals of luma and chroma. The derived filters are applied to the reconstructed luma signal producing the final chroma predictions.

### 2.2.2 Convolutional Filter and Calculation of Filter Coefficients

The proposed 8-tap filter consist of 6 spatial luma samples, a nonlinear term, and a bias term. The spatial luma samples (L0, . . . , L5) are obtained from the luma grid selecting the 6 luma samples closest to the chroma position C without down sampling as shown in FIG. 26. The predicted chroma value is obtained as,

$$predChromaVal = {c}_{0} L 0 + {c}_{1} L 1 + {c}_{2} L 2 + {c}_{3} L 3 + {c}_{4} L 4 + {c}_{5} L 5 + {c}_{6} nonlinear ( ( L 0 + L 3 + 1 ) >> 1 ) + {c}_{7} B ,$$

where nonlinear is CCCM's nonlinear operator and B is bias.

The filter coefficients are derived using ECM's division-free Gaussian elimination method and the necessary offsets are applied to samples prior to filter derivation.

Intra reference samples are used as additional input samples in filter derivation when the block has less than 64 chroma samples. CCCM's design of at most 6 rows and columns of intra reference samples is used.

Blocks having 256 chroma samples or more are divided into subblocks that have at most 256 chroma samples. Subblocks containing zero luma residual are skipped.

### 2.2.3 Bitstream Signalling

Usage of the mode is signalled with a CABAC coded TU level flag. One new CABAC context was included to support this. The CCRM flag is only signalled if the TU's luma Cbf is non-zero and the CU's predMode is either MODE_INTER or MODE_IBC.

### 3 Problems

There are several issues in the existing video coding techniques, which would be further improved for higher coding gain.
1. Several aspects such as filter terms, model types, applicated block types of a CCRM coded video unit may be further improved.
2. The CCRM estimated prediction would be competed with the original inter prediction. A lower cost residual is finally chosen. However, the concept of fusion may be involved to achieve a better result.
3. CCRM is applied to inter blocks as long as the luma component has non-zero cbf. The CCRM on/off decision may be further designed.
4. Currently, the CCRM model is applied with an input of a luma reconstruction and an output of an estimated chroma prediction. However, the estimated chroma prediction may be generated by adding a CCRM estimated residue block to the chroma prediction without CCRM.

### 4 Detailed Solutions

The detailed solutions below should be considered as examples to explain general concepts. These solutions should not be interpreted in a narrow way. Furthermore, these solutions can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

The term “motion vector” or “block vector” may refer to a vector of horizontal and vertical displacements between the locations of a reference block and the current block. The reference block can be a video unit in a reference picture in the RPL list. The reference block can also be a video unit in the current picture.

The term “LM” may refer to any linear regression based method, such as CCLM, MMLM, CCCM, GL-CCCM, CCCM without downsampling, GLM, GLM with luma value, etc. It may also be referred as the term “cross-component prediction (CCP)”.

The term “CCLM” may refer to a single model LM mode, it could be single model CCLM, single model CCCM, single model GL-CCCM, single model CCCM without downsampling, single model GLM, single model GLM with luma value, multi-model CCLM, MMLM, multi-model CCCM, multi-model GL-CCCM, multi-model CCCM without downsampling, multi-model GLM, multi-model GLM with luma value, etc.

The term “MMLM” may refer to a multi-model LM mode, it could be multi-model CCLM, MMLM, multi-model CCCM, multi-model GL-CCCM, multi-model CCCM without downsampling, multi-model GLM, multi-model GLM with luma value, etc.

The term “CCCM” may refer to a regular CCCM mode, or a GL-CCCM mode, or a CCCM without downsampling, CCRM, etc.

The term “GL-CCCM” may refer to a CCCM mode which considers gradients and locations of involved samples.

The term “CCCM w/o downsampling” may refer to a CCCM mode which considers non-downsampled luma samples.

The term “CCRM” may refer to a cross-component model based residual coding or derivation. It may also infer to a CCCM model based inter/IBC prediction (such as inter/IBC CCCM). It may also infer to a CCCM model based intra prediction (such as intra CCCM).

In the document, cross-component prediction (CCP) may refer to any cross-component prediction method such as any kind of CCLM/CCCM/GLM/GL-CCCM.

It is noted that the terminologies mentioned below are not limited to the specific ones defined in existing standards. Any variance of the coding tool is also applicable.
1) Residues (and/or predictions) of a chroma block may be derived based on a cross-component model.
   a. For example, the cross-component model may be a certain extrapolation filter (e . . . g, EIP, etc.).
   b. For example, the cross-component model may be a certain intrapolation filter (e.g., GLM, etc.).
   c. For example, the cross-component model may be a certain convolutional filter (CCCM, GL-CCCM, CCCM without downsampling, CCRM, inter CCCM, intra CCCM, etc.).
   d. For example, the cross-component model may be a certain linear filter (e.g., CCLM, MMLM etc.).
2) The cross-component model for residual coding (e.g., CCRM) may not contain a non-linear term.
   a. For example, the cross-component model for residual coding may contain linear terms and/or bias term, but not non-linear term.
3) A CCRM may be used for an intra or IBC block.
   a. For example, it may be used for an intra or IBC block in an intra (such as I) slice.
   b. For example, it may be used for an intra or IBC block in an inter (such as B or P) slice.
   c. For example, furthermore, it may be used for single tree.
   d. For example, furthermore, it may be used for dual tree.
   e. For example, in a single tree I slice, both luma and chroma are IBC (or intraTMP) coded, the CCRM may be generated based on reconstructed luma and chroma samples within the block vector retrieved/guided reference block, and the residual model is applied to estimate the reconstruction values of the chroma samples in the current block.
   f. For example, in dual tree, luma is IBC (or intraTMP) coded by chroma is intra coded, the CCRM may be generated based on reconstructed luma samples within the block vector retrieved/guided reference luma block as well as the reconstructed chroma samples collocated (e.g., at the same location) with that luma block, and the residual model is applied to estimate the reconstruction values of the chroma samples in the current block.
4) A CCRM may be used for a DBV coded chroma block.
   a. For example, based on the block vector of the DBV coded chroma block, a reference chroma block and its collocated luma block may be identified. Those samples may be used as training samples for a CCRM model calculation.
   b. For example, the derived CCRM model is applied to the reconstructed luma signal of the DBV chroma block to produce the final chroma predictions.
5) A CCRM model may be generated based on the correlation between luma and chroma reconstruction values from neighboring samples adjacent/nonadjacent to the current block.
   a. For example, alternatively, a CCRM model may be generated based on the correlation between luma and chroma reconstruction values in a reference block in the reference picture.
   b. For example, alternatively, a CCRM model may be generated based on the correlation between luma and chroma reconstruction values in a reference block in the current picture.
6) For example, the CCCM for intra prediction and CCCM for inter prediction (e.g., CCRM) may share a same logic.
   a. For example, both of them may follow a same logic to fetch training samples.
   b. For example, both of them may follow a same logic to determine a training area.
7) A CCRM model may be generated based on non-downsampled luma samples.
   a. For example, the CCRM model coefficients may be solved based on non-downsampled luma samples of the reference area as training samples.
   b. For example, a CCRM model may be applied to a chroma block wherein the chroma prediction of the current chroma block are generated based on non-downsampled luma samples of the collocated luma block.
8) More than one CCRM models (e.g., MM-CCRM) may be generated for a block.
   a. For example, the training samples of a CCRM may be divided into more than one category (e.g., two categories), and each group of samples may contribute to a unique model. In such way, multiple models may be generated each with its own filter coefficients. Each derived filter is applied to its corresponding group of luma reconstruction signal to produce the final predicted value of the current chroma sample which belongs to the corresponding category.
      i. For example, the training sample pairs in terms of luma and chroma sample pairs of a reference block (e.g., these training samples are in the reference frame) may be divided into more than one category, according to the multi-model CCRM (e.g., MM-CCRM) mode.
      ii. For example, alternatively, the training sample pairs in terms of luma and chroma sample pairs of neighboring samples adjacent/non-adjacent to the reference block (e.g., these training samples are in the reference frame) may be divided into more than one category, according to the multi-model CCRM (e.g., MM-CCRM) mode.
      iii. For example, alternatively, the training sample pairs in terms of luma and chroma sample pairs of neighboring samples adjacent/non-adjacent to the current video unit (e.g., these training samples are in the current frame) may be divided into more than one category, according to the multi-model CCRM (e.g., MM-CCRM) mode.
      iv. For example, furthermore, by following the same criteria (e.g., through a threshold), the luma samples in the current video unit are divided into more than one group, and for luma samples belong to each category, a corresponding model may be applied to generate the model estimated chroma samples belong to such group.
   b. For example, multiple sets of training samples may be utilized to derive the multiple models.
      i. In one example, there are two sets wherein the distance between the training samples and current samples are different.
   c. For example, the threshold (e.g., categorization threshold) to separate samples into different categories may be dependent on the values of samples within or neighboring to the training region.
      i. For example, the training region may be the reference block of the current video unit (e.g., these training samples are in the reference frame).
         1. For example, the reference block may be derived based on a block vector.
         2. For example, the reference block may be derived based on a motion vector.
      ii. For example, the threshold may be derived based on samples adjacent/nonadjacent to the reference block of the current video unit (e.g., these training samples are in the reference frame).
      iii. For example, the threshold may be derived based on samples adjacent/nonadjacent to the current video unit (e.g., these training samples are in the current frame).
      iv. For example, the threshold may be derived based on an average/medium/mid operation on more than one samples within or neighboring to the training region.
      v. For example, a categorization threshold may be derived based on non-downsampled luma sample values.
         1. Alternatively, a categorization threshold may be derived based on downsampled luma sample values.
         a. For example, a K-tap (such as K=6) downsampling filter may be used to downsize K surrounding luma samples into one subsampled luma sample value.
      vi. For example, a categorization threshold may be derived based on an offset removal approach.
         1. For example, the offset may be derived based on a luma sample located at a fixed position (such as top-left, or center, etc.) in a reference video unit.
         2. For example, the offset value for categorization threshold derivation and CCRM model calculation may be same.
      vii. For example, the categorization threshold may be derived based on subblock level.
      viii. For example, the categorization threshold may be derived based on CU/PU/TU level.
      ix. For example, a categorization threshold may be calculated based on (downsampled or non-downsampled) luma prediction samples.
      x. For example, a categorization threshold may be derived based on luma residual samples values.
         1. For example, for a second video unit (e.g., subblock) which doesn't have non-zero residues, the prediction samples of such video unit may not be counted into the calculation process of the categorization threshold for the first video unit.
         a. For example, the second video unit may be a subset of the first video unit.
         b. For example, the second video unit may be equal to the first video unit.
   d. For example, MM-CCRM may be applied based on subblock level.
      i. For example, the subblock size may be pre-defined.
         1. For example, the pre-defined subblock block size may be 16×16, or 32×32, etc.
         2. For example, a pre-defined rule may be used to determine the subblock size of MM-CCRM for a certain video unit.
         a. For example, the subblock block size may be adaptive to the block dimensions (width and/or height) of the current video block.
         b. For example, a minimum number of chroma samples may be assured for a subblock of MM-CCRM coded video unit.
      ii. For example, if a video unit is greater than the pre-defined subblock size, the video unit may be divided into more than one subblock and perform MM-CCRM.
      iii. For example, at least one subblock of the video unit may have more than one CCRM model.
      iv. For example, each subblock (and its associated training region) may have its own categorization threshold.
         1. For example, the categorization threshold of a certain subblock may be calculated based on training sample values belong to such subblock.
         a. For example, the luma training samples in the reference block may be used to calculate the categorization threshold.
      v. For example, all subblocks (and their associated training region) may share the same categorization threshold.
         1. For example, one categorization threshold may be calculated and used for all subblocks.
         2. For example, the categorization threshold of all subblocks in the current video unit may be calculated based on training sample values of the current video unit.
         3. For example, the categorization threshold of all applicable subblocks in the current video unit may be calculated based on training sample values of the current video unit.
         a. For example, a subblock which does not contain a non-zero residual may not be counted.
      vi. For example, each subblock of the video unit may have its own training samples, and the training samples of a certain subblock may be divided into more than one category.
         1. For example, the training samples in the reference video unit of the reference picture may be categorized based on subblock.
      vii. For example, the training samples from the current picture may be categorized into more than one group, but may not be divided into subblocks.
   e. For example, MM-CCRM may be applied based on TU level (or PU/CU level).
      i. For example, MM-CCRM may be applied on a TU/CU/PU basis (e.g., the TU/CU/PU may not split into subblocks for the application of MM-CCRM).
      ii. For example, whether to use TU/PU/CU based multi-model CCRM (i.e., MM-CCRM) may be determined at TU/PU/CU level.
         1. For example, a video unit (e.g., TU/PU/CU) may choose to use subblock based single model CCRM or TU/PU/CU based MM-CCRM.
         a. For example, the decision may be made at TU/PU/CU level.
   f. For example, whether and/or how to apply MM-CCRM (and/or CCRM) may be derived based on coding information at both encoder and decoder sides (e.g., without signalling).
      i. In one example, it may be derived on-the-fly, e.g., using the information of previously coded samples/reconstructed samples.
      ii. For example, the determination of whether to use subblock based CCRM or TU/CU/PU level CCRM may be implicitly derived based on coding information (e.g., without signalling).
      iii. For example, the determination of whether to use M1×M2 subblock based CCRM or N1×N2 subblock based CCRM may be implicitly derived based on coding information (e.g., without signalling).
         1. For example, M1=16 or 8 or 32 or TU/CU/PU.
         2. For example, M2=16 or 8 or 32 or TU/CU/PU.
         3. For example, N1=16 or 8 or 32 or TU/CU/PU.
         4. For example, N2=16 or 8 or 32 or TU/CU/PU.
         5. For example, M1!=N1 and/or M2!=N2.
      iv. For example, the determination of whether to use subblock based MM-CCRM or TU/CU/PU level MM-CCRM may be implicitly derived based on coding information (e.g., without signalling).
      v. For example, the determination of whether to use M1×M2 subblock based MM-CCRM or N1×N2 subblock based MM-CCRM may be implicitly derived based on coding information (e.g., without signalling).
         1. For example, M1=16 or 8 or 32 or TU/CU/PU.
         2. For example, M2=16 or 8 or 32 or TU/CU/PU.
         3. For example, N1=16 or 8 or 32 or TU/CU/PU.
         4. For example, N2=16 or 8 or 32 or TU/CU/PU.
         5. For example, M1!=N1 and/or M2!=N2.
      vi. For example, the determination of whether to use single model CCRM or MM-CCRM may be implicitly derived based on coding information (e.g., without signalling).
      vii. For example, the determination may be based on a decoder derived cost based method.
         1. For example, the decoder derived cost may be calculated based on minimizing the SAD/SATD/SSE/MSE between the model estimate samples values and true reconstructed samples values, wherein the samples may refer to at least one of the training samples.
         2. For example, the method with lower cost may be selected as the final method being applied to the current video unit.
      viii. For example, the determination may be based on information of a reference picture.
         1. For example, the determination may be based on POC distance of current picture and its reference picture.
         2. For example, the determination may be based on reference index.
   g. For example, whether and/or how to apply MM-CCRM (and/or CCRM) may be signalled in the bitstream.
      i. For example, a syntax element (e.g., a flag, an index, etc.) may be signalled conditioned on whether the current block is CCRM coded.
         1. For example, if a video unit is CCRM coded, a syntax element (e.g., a flag, an index, etc.)) may be further signalled to indicate whether it is MM-CCRM or not.
      ii. For example, a syntax element (e.g., a flag, an index, etc.)) may be signalled to indicate whether it is subblock based MM-CCRM or TU/CP/PU based MM-CCRM.
      iii. For example, a syntax element (e.g., a flag, an index, etc.)) may be signalled to indicate whether it is subblock based CCRM or TU/CP/PU based CCRM.
      iv. For example, the syntax element may be signalled conditioned on the block dimensions (width and/or height).
   h. For example, a block restriction may be applied to indicate the allowance of a MM-CCRM mode.
      i. In one example, assume the width and height of a chroma CU/PU/TU are denoted as W and H, then MM-CCRM may be allowed if at least one of the following conditions is met:

$$\begin{matrix}1. & \\ W * H > T 0 or W * H >= T 0 ( e . g . , T 0 = 16 or 32 or 64 or 128 ) & \end{matrix}$$

$$\begin{matrix}2. & \\ W > T 1 , or W >= T 1 & \end{matrix}$$

$$\begin{matrix}3. & \\ H > T 2 , or , H >= T 2 & \end{matrix}$$

$$\begin{matrix}4. & \\ Min ( W , H ) > T 3 , or , Min ( W , H ) > = T 3 & \end{matrix}$$

$$\begin{matrix}5. & \\ Max ( W , H ) < T 4 , or , Max ( W , H ) <= T 4 & \end{matrix}$$

$$\begin{matrix}6. & \\ W < T 5 * H , or , W <= T 5 * H & \end{matrix}$$

$$\begin{matrix}7. & \\ W > T 6 * H , or , W >= T 6 * H & \end{matrix}$$

$$\begin{matrix}8. & \\ H < T 7 * W , or , H <= T 7 * W & \end{matrix}$$

$$\begin{matrix}9. & \\ H > T 8 * W , or , H >= T 8 * W & \end{matrix}$$

$$\begin{matrix}10. & \\ W * H < T 9 , or W * H <= T 9 & \end{matrix}$$

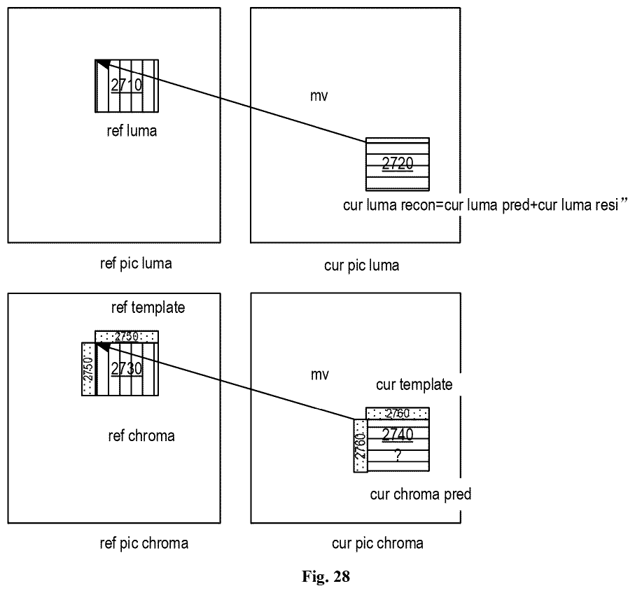

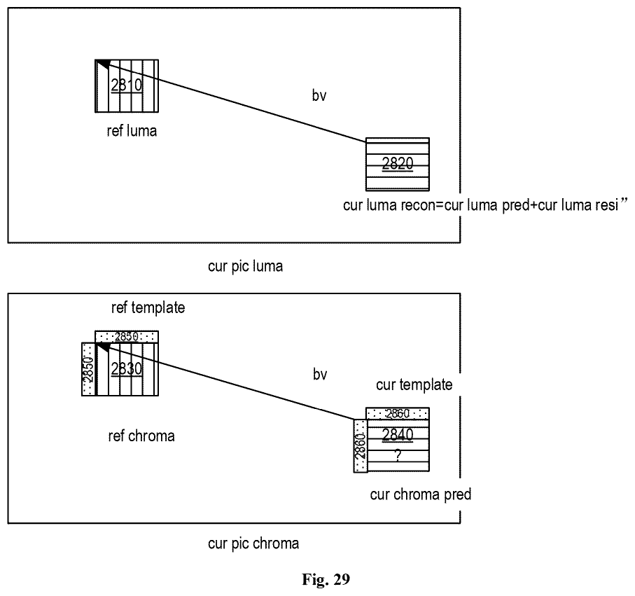

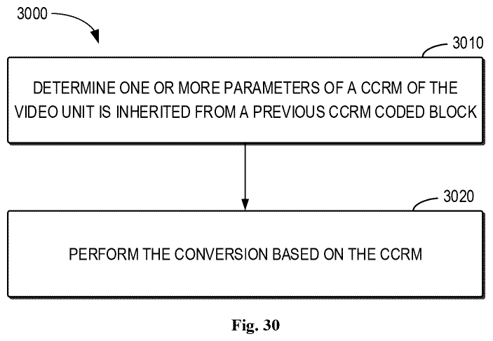

ii. In one example, for blocks with certain tools enabled (e.g., affine motion compensation is enabled), the MM-CCRM may be disallowed.
i. For example, a CCRM coded video unit may always use multi-model CCRM.
   i. Alternatively, a CCRM coded video unit may use single model CCRM or multi-model CCRM.
9) Chroma Cb and Cr may share one CCRM.
a. Alternatively, chroma Cb and Cr may build its own CCRM.
10) Sample value and/or gradient and/or location information may be considered for the filter design for a CCRM model.
   a. For example, at least one K-tap filter may be used for a CCRM model, which consists of K1 sample term(s), K2 gradients term(s), K3 location/positional term(s), K4 non-linear term(s), K5 bias term(s), and etc.
      i. For example, K1=0 or 1 or 2 or 5 or 6
      ii. For example, K2=0 or 1 or 2 or 4
      iii. For example, K3=0 or 1 or 2 or 4
      iv. For example, K4=0 or 1 or 2 or 4
      v. For example, K5=0 or 1
      vi. For example, K=K1+K2+K3+K4+K5
      vii. For example, the sample term may be calculated based on luma sample values.
      viii. For example, the gradient term may be calculated based on more than one sample adjacent to a certain luma sample.
      ix. For example, the location/positional term may be calculated based on horizontal and/or vertical coordinates of a certain luma sample, wherein the coordinate may be relative to the top-left position of a certain reference area.
      x. For example, the non-linear term may be a square of a certain value (e.g., a bit-depth related mid value such as 512 or 256, or a certain luma value).
      xi. For example, the non-linear term may be a square of a gradient value based on a certain gradient term.
      xii. For example, an offset may be subtracted from a term of the K-tap filter.
         1. For example, the offset may be derived based on a pre-defined rule (such as the value of the top-left training sample in the training area, or an average/mid value of more than one sample in the training area).
      xiii. For example, the coefficients of the K-tap filter may be solved by a gaussian elimination solver.
      xiv. For example, the coefficients of the K-tap filter may be solved by an LDL decomposition method.
      i. For example, the coefficients of the K-tap filter may be solved by linear regression.
      ii. For example, the coefficients of the K-tap filter may be solved by linear equation.
   b. For example, more than one filter may be used, and the final prediction may be derived based on fusing the filtered output of multiple filters together.
      i. For example, the weights to fuse multiple filtered values may be solved by a gaussian elimination solver.
      ii. For example, the weights to fuse multiple filtered values may be solved by an LDL decomposition method.
11) For example, more than one filter may be allowed for a CCRM coded video unit, and which filter is finally selected may be signalled or divided.
   a. For example, syntax elements may be signalled to indicate which filter (e.g., CCLM or CCCM) is used for the CCRM mode.
   b. For example, indicate which filter (e.g., CCLM or CCCM) is used for the CCRM mode may be determined based on template cost from both encoder and decoder.
   c. For example, indicate which filter (e.g., CCLM or CCCM) is used for the CCRM mode may be determined based on decoder derived costs from both encoder and decoder.
12) The filter output may be clipped to a value.
   a. For example, it may be clipped based on the reconstruction values in the training area.
      i. For example, the training area may be derived based on a block vector (or motion vector).
      ii. For example, the training area may be adjacent to the current block.
      iii. For example, the training area may be a reference region of the current block.
      iv. For example, the filter output may be clipped within the min and max of the reconstructed (or predicted) luma samples values in a training area.
   b. For example, it may be clipped based on the reconstruction values (or predicted values) in the collocated luma block of current chroma block.
      i. For example, it may be clipped within the min and max of the current block luma reconstructed values (or predicted values).
   c. For example, it may be ignored/discarded/not used if the value is outside of a valid range.
13) The CCRM parameters may be stored in a buffer and used for a future block's coding.
   a. For example, CCRM parameters for a video unit (e.g., CU, PU, color component, Cb, Cr, etc.) may include model type, model coefficients, whether it is single model or multiple models, threshold to separate samples into multiple models, and etc.
   b. For example, it may be stored in a local buffer for the coding of a future block in the current picture.
   c. For example, it may be stored in a temporal/picture/frame buffer for the coding of a future block in a future decoded picture.
      i. For example, the CCRM parameters of current frame/picture may be stored which can be referenced for the CCP process of future frames/pictures.
      ii. For example, it may be stored associated with the motion and mode information of a video unit.
14) A video block may inherit model parameters from a previous CCRM coded block.
   a. For example, the video block may be coded by a kind of CCP inherited mode.
   b. For example, the video block may be coded by a kind of CCP merge (e.g., CCmerge) mode.
   c. For example, the model parameters of a previous CCRM coded block may be stored in a buffer (e.g., local buffer, picture buffer, temporal buffer, history based LUT, etc.)
   d. In one example, the parameters may refer to the filter information, the linear or non-linear parameters of the model, the model index etc. al.
   e. For example, at least one syntax element may be signalled at a video unit level (e.g., block level, tu/pu/cu level, etc.) to specify whether and/or how to use CCRM model inheritance mode (e.g., CCRM merge mode).
      i. For example, an indicator may be signalled at video unit level to specify whether the current video unit uses regular CCRM mode or CCRM model inheritance mode.
         1. For example, alternatively, the indicator is signalled conditioned based on at least one type of CCRM is used for the current video unit.
         2. For example, a first syntax is signalled to indicate the current video unit uses a type of CCRM mode, then a second syntax is further signalled which type of CCRM mode is used.
         a. Furthermore, alternatively, the second syntax may be signalled only if there are at least one available CCRM candidate.
      ii. For example, alternatively, if CCRM model inheritance mode is used, another syntax (e.g., an index) may be further signalled to specify which CCRM model candidate is selected to be inherited.
      iii. For example, alternatively, an indicator may be signalled at video unit level to specify whether the current video unit uses CCRM model inheritance mode, and/or, which candidate is used for CCRM model inheritance mode.
   f. For example, if the CCRM model inheritance mode is used, a CCRM model candidate list may be generated.
      i. For example, the maximum length of list size may be pre-defined in the bitstream (e.g., size equal to 6 or 10 or 12 candidate models).
         1. Furthermore, the size of history table may be pre-defined (e.g., size equal to 5 or 6).
      ii. For example, the CCRM model candidate may be obtained based on previously coded CCRM blocks, which are spatial adjacent neighbors, and/or temporal candidate, and/or spatial non-adjacent neighbors, and/or history based CCRM candidate, and/or shifted candidates, and/or default CCRM candidate.
         1. For example, the candidate inserting order may follow a pre-defined rule, such as spatial adjacent→temporal→spatial non-adjacent→history→shifted→default.
         2. For example, the CCRM candidates may be checked at subblock (e.g., 4×4) granularity.
         a. For example, each continuous subblock within a pre-defined region may be checked, e.g., all 4×4 subblocks above and left to the current video unit may be checked.
         b. Alternatively, a pre-defined scatter check order may be used.
         3. For example, the positions non-adjacent neighbor blocks may be based on the block dimensions of the current video unit, e.g., a certain distance from the current video unit, wherein the distance is proportional to the width and/or height of the current video unit.
         4. For example, a motion shift (e.g., zero vector, or non-zero vector) may be used to locate the temporal candidates.
         a. For example, the motion shift may be based on a motion vector of a neighbor block.
         b. For example, the temporal candidates may be from a collocated picture.
         c. Alternatively, the temporal candidates may be from a reference picture which may not be a collocated picture.
         5. For example, the history based CCRM candidates may be from a first-in-first-out history table.
         a. For example, the history table may be initialized at tile/ctu row/slice/picture level.
      iii. For example, pruning/redundancy/similarity check may be applied for the CCRM candidate list construction.
         1. For example, if the to-be-inserted candidate is different from specified candidates already in the list, the to-be-inserted candidate is inserted to the list.
         a. For example, the specified candidates may refer to all available CCRM candidates in the list.
         b. Alternatively, the specified candidates may refer to one or more specified (e.g., the one at the last, and/or the last—X in the list, wherein X is a pre-defined constant) CCRM candidates in the list.
         2. For example, same pruning/redundancy/similarity check rule may be applied for all types of CCRM candidates.
         a. Alternatively, different pruning/redundancy/similarity check rules may be applied for different types of CCRM candidates
      iv. For example, CCRM candidate reordering may be applied.
         1. For example, the CCRM candidates in the list may be sorted based on a decoder derived cost (e.g., template cost).
         2. For example, the cost may be derived based on applying the CCRM candidate to a reference region/block of the current video unit.
         a. For example, the reference region/block may be identified by the motion vector of the current block.
         b. For example, for each CCRM candidate, the model is firstly applied to the reference luma to get a predicted reference chroma, secondly, the cost is computed as the absolute difference between the true reference chroma and the predicted reference chroma.
         3. For example, the cost may be derived based on applying the CCRM candidate to a neighboring region/block of the current video unit.
         a. For example, the neighboring region/block may be above/left neighbors of the current block.
         b. For example, for each CCRM candidate, the model is firstly applied to the neighboring luma to get a predicted neighboring chroma, secondly, the cost is computed as the absolute difference between the true neighboring chroma and the predicted neighboring chroma.
         4. For example, based on the above decoder derived costs, the CCRM candidates may be sorted from lowest cost to highest cost, and the one with minimum cost is ordered at the first of the list.
   g. For example, if CCRM model inheritance mode is used, a specified CCRM candidate model is directly applied to the current video unit, without model estimation.
      i. For example, the first candidate of the CCRM list may be always used for the CCRM model inheritance mode.
      ii. Alternatively, which candidate of the CCRM list is used to the CCRM model inheritance mode coded block, may be signalled in the bitstream.
      iii. For example, for an RRIBC block coded with a CCRM mode inheritance mode, the inherited CCRM model may be applied based on the inherited RRIBC flip type.
         1. For example, if the inherited RRIBC flip type indicates that the inherited CCRM model is from a RRIBC coded block (e.g., the inherited RRIBC flip type is non-zero), the CCRM filter taps for the current block may be flipped according to the inherited RRIBC flip type.
         a. For example, when generating the CCRM filter taps from non-downsampled luma samples, the filter taps of non-downsampled luma samples may be swapped/flipped.
         2. For example, assume the 8-tap CCRM model consists of 6 spatial luma samples, a nonlinear term, and a bias term. The spatial luma samples (L0, . . . , L5) are obtained from the luma grid selecting the 6 luma samples closest to the chroma position C without down sampling. The predicted chroma value is obtained as, predChromaVal=c0 L0+clL1+c2L2+c3L3+c4L4+c5L5+c6 nonlinear((L0+L3+1)>>1)+c7B, where nonlinear is CCCM's nonlinear operator and B is bias. FIG. 29 shows luma samples L0, . . . , L5 in relation to the chroma sample C.
         a. For example, if the inherited CCRM model is from a horizontal flipped RRIBC coded block, when applying the inherited CCRM model to the current block (e.g., no matter whether the current block is RRIBC coded or not), the luma samples L1 and L2 may be swapped. And the luma samples L4 and L5 may be swapped.
         b. For example, if the inherited CCRM model is from a vertical flipped RRIBC coded block, when applying the inherited CCRM model to the current block (e.g., no matter whether the current block is RRIBC coded or not), the luma samples L1 and L4 may be swapped. And the luma samples L0 and L3 may be swapped. Moreover, the luma samples L2 and L5 may be swapped.
   h. For example, the CCRM model of a CCRM coded block may be stored in a buffer.
      i. For example, the stored CCRM model information may include the following information.
         1. CCRM model coefficients/taps/parameters of Cb and Cr components, respectively.
         2. middle value of the CCRM coded block
         3. bit depth of the CCRM coded block
         4. the offset value of Y component of the CCRM coded block
         5. the offset values of U and/or V components of the CCRM coded block
         6. the RRIBC flip type of the CCRM coded block.
15) A final prediction may be generated from a weighted sum of fusing/blending multiple hypotheses wherein at least one hypothesis is a CCRM based prediction.
   a. In one example, the final prediction of a block may be generated based on multiple prediction candidates from different CCRMs.
      i. For example, more than one CCRM prediction may be fused together.
      ii. For example, the weights/coefficients of different fusion terms may be solved based on a Gaussian elimination method.
      iii. For example, the weights/coefficients of different fusion terms may be solved based on an LDL decomposition method.
      iv. For example, a bias term may be involved for the fusion.
      v. For example, a non-linear term may be involved for the fusion.
   b. In one example, more than multiple CCRM models may be derived to obtain a fused prediction.
      i. A fused prediction may refer to prediction generated by weighting sum.
      ii. In one example, P0 on luma and chroma may be used to derive the CCRM model M0, P1 on luma and chroma may be used to derive the CCRM model M1, and the final chroma prediction may be derived to be wc0×Pc0+wc1×Pc1, wherein Pc0 and Pel are chroma prediction obtained with M0 and M1 and wc0, wc1 are weighting factors.
      iii. P0 and P1 may be predictions from two different directions in Bi-prediction.
   c. In one example, the chroma prediction obtained by CCRM may be fused with other predictions.
      i. For example, the chroma prediction obtained by CCRM may be fused with angular intra-prediction.
      ii. For example, the chroma prediction obtained by CCRM may be fused with CCLM prediction.
      iii. For example, the chroma prediction obtained by CCRM may be fused with CCCM prediction.
      iv. For example, the chroma prediction obtained by CCRM may be fused with the original prediction (e.g., inter or IBC prediction) without CCRM.
         1. For example, assume the final chroma prediction may be derived to be (w0×P0+w1×P1+offset)>>shift, wherein P0 denotes the chroma prediction obtained by CCRM and P1 denotes the chroma prediction without CCRM,
         a. the fusion weights w0 and w1 may be fixed and/or pre-defined, e.g., w0=3 and w₁=1, or w0=2 and w₁=2.
         b. the shift value may be a constant value which can be deduced based on w0 and w1, e.g., shift=log 2(w0+w1).
         c. the offset may be a constant value which can be deduced based on shift and/or fusion weights, e.g., offset=shift>>1, or offset=log 2(w0+w1))>>1.
         d. Alternatively, the fusion weights w0 and w1 may be adaptively decided based on coding information (e.g., block dimensions, prediction modes of neighbors, etc.)
   d. In one example, the weighting factors of different hypotheses in the fusion/blending process may be derived based on a pre-defined rule. Assume the final prediction P is derived as P=w0×P0+w1×P1+w2×P2+ . . . , wherein w0, w1, w2 are weighting factors.
      i. For example, fixed values may be assigned to w0, w1, w2 . . . .
      ii. For example, blocks based w0, w1, w2 . . . may be assigned.
      iii. For example, sample based weighting factors may be assigned for each prediction (e.g., at least two different weights may be applied for different samples in one hypothetic prediction block).
      iv. For example, w0, w1,w2 may be derived on-the-fly (e.g., based on decoded neighboring samples, prediction modes of neighbors, and/or template costs.)
   e. In one example, an indicator of the weighting factors of different hypotheses in the fusion/blending process may be signalled in the bitstream.
      i. For example, a look-up-table containing multiple sets of weighting factors may be defined, and an index may be signalled to look-up the corresponding weights.
   f. For example, the sample value of the final fused/blended prediction may be clipped to a pre-defined range, e.g., it may be required to no less than T1 and no greater than T2, wherein T2 may be dependent on bit-depth. For example, Clip1(x)=Clip3(0, (1<<BitDepth)−1,x).
16) Whether a CCRM prediction is fused with another prediction may be signalled in the bitstream.
   a. For example, a flag may be signalled at video unit level (e.g., TU/PU/CU/slice header/picture header/SPS/PPS level) to indicate such CCRM fusion mode.
   b. Alternatively, a CCRM prediction may be always fused with another prediction without signalling.
17) Bi-prediction may be managed in a way different from uni-prediction for CCRM. In the following discussion, suppose the predictions from the two directions are P0 and P1, and the bi-prediction is denoted as Pb=w0×P0+w1×P1, wherein w0 and w1 are weighting factors.
   a. In one example, the Pb on luma and chroma may be used to derive the CCRM model.
   b. In one example, P0 or P1 on luma and chroma may be used to derive the CCRM model.
   c. In one example, it may be signaled which kind of prediction is used to derive the CCRM model.
18) The allowance of CCRM mode may be dependent on at least one of the following aspects:
   a. Prediction modes of the video unit (e.g., MODE_INTRA, MODE_INTER, MODE_IBC, MODE_PLT, etc.)
   b. The transform type of the video unit (e.g., ACT, color transform, Transform skip, etc.)
   c. SBT (e.g., whether SBT is applied to the current video unit)
   d. Non-zero coefficient number of the video unit
   e. Luma coefficients (e.g., luma coefficient values, the absolute sum of all luma coefficients, last scan position of non-zero luma coefficients, AC values, DC value, etc.) Partition tree type (e.g., single tree, dual tree)
   f. slice type (e.g., I, B, P slices)
   g. color format (e.g., 4:0:0 or not)
   h. the availability of chroma component
   i. For example, CCRM may not be allowed for ACT, and/or 4:0:0 color format.
   j. For example, CCRM on/off may be determined based on the last scan position of non-zero luma coefficients.
      i. For example, if the last scan position is less than a threshold, CCRM may be inferred to be disabled for the current chroma unit thus no syntax element is signaled for the CCRM usage.
         1. For example, the threshold may be a fixed constant (such as 1).
         2. for example, the threshold may be a variable based on coding information such as block dimensions.
      ii. For example, such condition may be checked if the luma is not transform skip coded.
      iii. For example, such condition may be checked no matter whether or not luma is transform skip coded.
   k. For example, CCRM on/off may be determined based on the absolute sum of non-zero luma coefficients.
      i. For example, it may be determined based on the absolute sum of all luma coefficients (e.g., both AC and DC).
      ii. For example, it may be determined based on the absolute sum of all luma AC coefficients.
      iii. For example, it may be determined based on the luma DC coefficient value.
      iv. For example, it may be determined based on at least one luma coefficient value (e.g., DC and/or AC).
      v. For example, if the absolute sum is less than a threshold, CCRM may be inferred to be disabled for the current chroma unit thus no syntax element is signaled for the CCRM usage.
         1. For example, the threshold may be a fixed constant value.
         2. For example, the threshold may be a variable based on coding information such as block dimensions.
      vi. For example, such condition may be checked if the luma is not transform skip coded.
      vii. For example, such condition may be checked no matter whether or not luma is transform skip coded.
      viii. For example, such condition may be checked along with a block size (e.g., TU width and/or width) based condition.
   l. For example, CCRM may not be applied to a chroma component if transform skip is used on luma component.
      i. For example, if transform skip is used on luma component, CCRM may be inferred to be disabled for the current chroma unit (e.g., Cb and/or Cr).
         1. Furthermore, in such case, no syntax element is signaled for the CCRM usage on this video unit.
      ii. Alternatively, if transform skip is used on luma component, CCRM may be inferred to be always enabled for the current chroma unit (e.g., Cb and/or Cr).
         1. Furthermore, in such case, no syntax element is signaled for the CCRM usage on this video unit.
19) The application of CCRM may be dependent on template information.
   a. For example, whether CCRM is allowed to be used to a video unit may be dependent on template costs.
      i. For example, if the CCRM is determined to be disabled for the current video unit by a template-cost-based method (i.e., CCRM on/off is inferred other than signalled), no syntax element is signaled for the CCRM usage on this video unit.
   b. For example, as illustrated in FIG. 28, assume the current block is inter coded, two costs (e.g., SAD) may be calculated: a first cost is calculated based on the absolute difference between a CCRM-model-predicted current template and the true reconstruction of the current template, a second cost is calculated based on the difference between the reference template and the true reconstruction of the current template. If the first cost is lower than the second one, CCRM is inferred to be used to the current chroma unit, otherwise, the current chroma unit is coded without CCRM. FIG. 28 shows an example of current template (2760) and reference template (2750) involved for current inter block's (2720, 2740) CCRM coding.
      i. For example, the CCRM-model may be calculated based on the relationship between reference luma block (2710) and reference chroma block (2730).
      ii. For example, if it is determined that CCRM is used, then the CCRM-model may be applied to current luma reconstruction block (i.e., input to the CCRM model), and generate the CCRM-model-predicted current chroma prediction (i.e., output of the CCRM model).
      iii. For example, in such case (i.e., CCRM on/off is inferred other than signalled), no syntax element is signaled for the CCRM usage on this video unit.
      iv. For example, such template cost method may be applied to inter coded blocks.
   c. For example, as illustrated in FIG. 29, assume the current block is IBC coded, two costs (e.g., SAD) may be calculated: a first cost is calculated based on the absolute difference between a CCRM-model-predicted current template and the true reconstruction of the current template, a second cost is calculated based on the difference between the reference template and the true reconstruction of the current template. If the first cost is lower than the second one, CCRM is inferred to be used to the current chroma unit, otherwise, the current chroma unit is coded without CCRM. FIG. 29 shows an example of current template (2860) and reference template (2850) involved for current IBC block's (2820, 2840) CCRM coding.
      i. For example, the CCRM-model may be calculated based on the relationship between reference luma block (2810) and reference chroma block (2830).
      ii. For example, if it is determined that CCRM is used, then the CCRM-model may be applied to current luma reconstruction block (i.e., input to the CCRM model), and generate the CCRM-model-predicted current chroma prediction (i.e., output of the CCRM model).
      iii. For example, in such case (i.e., CCRM on/off is inferred other than signalled), no syntax element is signaled for the CCRM usage on this video unit.
      iv. For example, such template cost method may be applied to IBC coded blocks.
   d. For example, whether a template-cost-based method is used to determine the CCRM on/off may be dependent on whether the current video unit (e.g., TU) has residues/non-zero-coefficients and/or the SBT usage.
      i. For example, for the residual zero-out part of a SBTcoded current CU, the template cost based CCRM decision may not be applied.
      ii. For example, for the has residue part of a SBT coded current CU, the template cost based CCRM decision may not be applied.
      iii. For example, if the CBF flag of the current luma TU is equal to false, the template cost based CCRM decision may not be applied.
   e. For example, for a TU resultant from a SBT coded CU (e.g., the TU size is smaller than the CU size), the template may be constructed by neighboring samples outside the whole CU.
   f. For example, for subblock/subpartition based inter/IBC mode, as each subblock may have its own motion vector, the motion vector of a pre-defined subblock may be used to locate the reference template.
      i. For example, for an affine/sbTMVP coded TU, the MV of a certain subblock (e.g., top-left corner, or center, etc.) may be used.
      ii. For example, for a GPM inter-inter coded TU, the MV of a certain partition (e.g., part 0 or part 1) may be used.
      iii. For example, for a GPM inter-intra coded TU, the MV of the inter part may be used.
      iv. For example, for a GPM coded TU, the MV after TM/MMVD may be used.
         1. Alternatively, the MV before TM/MMVD may be used.
      v. Alternatively, such template-based method may not be applied for CCRM on/off decision if the current TU is coded with a kind of subblock/subpartition based inter/IBC mode.
   g. For example, if subblock based CCRM is applied, the samples of the CCRM-model-predicted current template may be constructed on subblock basis.
      i. For example, the samples of the CCRM-model-predicted current template may be constructed by applying multiple CCRM models of boundary subblocks (e.g., above and/or left boundary subblocks).
      ii. For example, in case that a boundary subblock doesn't have valid CCRM model, corresponding template samples may not be calculated for the cost calculation.
         1. For example, alternatively, it may be filled with true reconstruction template samples.
   h. For example, the samples of the CCRM-model-predicted current template may be constructed from a same CCRM model.
20) A CCRM model may be applied to a luma residual block and output a CCRM estimated chroma residual block.
   a. For example, a final chroma prediction block may be generated by adding a first candidate to a second candidate.
      i. For example, the first candidate may be based on a CCRM estimated chroma residual block, and the second candidate may be based on a chroma prediction block before/prior to CCRM.
      ii. Moreover, alternatively, the two candidates may be blended/fused based on a weighted sum method.
         1. For example, the weights of the two candidates may be fixed, and/or based on a pre-defined rule.
   b. For example, the model may be derived from reference reconstruction samples and applied to the current residue samples.
      i. For example, CCRM model coefficients may be solved/derived based on a group of training samples, wherein the training samples may refer to luma (non-downsampled, or, downsampled) and chroma samples in a reference block.
      ii. For example, the derived model coefficients may be applied to the luma residual block (non-downsampled, or, downsampled), and output a CCRM estimated chroma residual block.
   c. For example, different offset values may be used during the CCRM model coefficients derivation process and the CCRM model application process. Assume a 8-tap CCRM model consist of 6 spatial luma samples, a nonlinear term, and a bias term: for the model coefficients derivation, the estimated reference chroma value is obtained as estChroma Val_{ref}=c0(L0_{ref}−offset_{ref})+c1(L1_{ref}−offset_{ref})+c2(L2_{ref}−offset_{ref})+c3(L3_{ref}−offset_{ref})+c4(L4_{ref}−offset_{ref})+c5(L5_{ref}−offset_{ref})+c6nonlinear((L0_{ref}+L3_{ref}+1)>>1)+c7 B_{ref}, wherein (L0_{ref}, . . . , L5_{ref}) are six luma reconstruction samples in the reference block, nonlinear is CCCM's nonlinear operator, B_{ref} is bias, and offset_{ref} is a block based variable; for the model application, the estimated current chroma residue value is obtained as estChromaResiVal_{cur}=c0(L0_{cur}−offset_{cur})+c1(L1_{cur}−offset_{cur})+c2(L2_{cur}−offset_{cur})+c3(L3_{cur}−offset_{cur})+c4(L4_{cur}−offset_{cur})+c5(L5_{cur}−offset_{cur})+c6nonlinear((L0_{cur}+L3_{cur}+1)>>1)+c7 B_{cur}, wherein (L0_{cur}, . . . , L5_{cur}) are six luma residue samples in the current block, nonlinear is CCCM's nonlinear operator, B_{cur} is bias, and offset_{cur} is a block based variable.
      i. For example, the offset value may be derived based on at least one training sample.
         1. For example, the offset may be derived based on a certain luma training sample (e.g., at a fixed position of the luma reference block, such as top-left, center samples value).
         2. For example, the offset may be derived based on an average/median of at least two training samples (e.g., all luma training samples).
      ii. For example, the offset may be defined as a fixed constant (e.g., 0).
      iii. For example, a first offset (e.g., offset_{ref}) may be used for the model coefficients (e.g., c0 . . . c7) derivation process.
         1. For example, a gaussian elimination solver may be used to minimize the difference between the CCRM model estimated reference chroma block (e.g., input of the model may be the true reference luma reconstruction block) and the true reference chroma reconstruction block.
         2. For example, the first offset (e.g., offset_{ref}) may be derived based on the average of all sample values in the true reference luma reconstruction block.
      iv. For example, a second offset (e.g., offset_{cur}) may be used for the model application process.
         1. For example, the CCRM model associated with the derived model coefficients may be applied to the current luma residue block and output an estimated chroma residue block for the current block.
         2. For example, the second offset (e.g., offset_{cur}) may be fixed to be equal to 0.
   d. For example, different bias values may be used during the CCRM model coefficients derivation process and the CCRM model application process.
      i. For example, the bias value may be derived based on the bitdepth of the luma and chroma prediction/reconstruction samples in the bitstream (e.g., it may be equal to 1<< (bitdepth−1)).
         1. Alternatively, it may be equal to a fixed constant (e.g., 0).
      ii. For example, a first bias (e.g., B_{ref}) may be used for the model coefficients derivation process.
         1. For example, B_{ref} may be equal to 1<<(bitdepth−1).
      iii. For example, a second offset (e.g., B_{cur}) may be used for the model application process.
         1. For example, B_{cur} may be fixed to be equal to 0.
   e. For example, whether a CCRM model is used to predict current chroma prediction or current chroma residue may be signalled in the bitstream.
      i. Alternatively, it may be implicitly derived based on decoder information.
      ii. Alternatively, the CCRM model may be always applied to prediction current chroma residue.
21) The disclosed CCRM mode may be based on one of the following filters:
   a. CCLM and/or its variant
   b. MMLM and/or its variant
   c. CCCM and/or its variant (e.g., GL-CCCM, non-downsampled-CCCM, BVG-CCCM, inter CCCM, intra CCCM, etc.)
   d. GLM and/or its variant
   e. Any cross-component prediction that uses information in one channel/component to predict information in another channel/component
   f. Any filter-based prediction wherein the filter coefficients are solved based on correlation between prediction and/or reconstruction information.
22) Block restrictions may be applied to limit the application of a certain type of CCP mode.
   a. For example, a CCP mode may only be allowed to be used for block sizes satisfies a pre-defined rule.
   b. For example, syntax elements may be signalled only when the CCP mode is applicable.
   c. For example, if the CCP mode is not allowed to be used, syntax elements may be inferred to a certain value indicating no such CCP mode is used for such block.
   d. For example, at least one of the following block restrictions may be applied to the CCRM mode (suppose W denotes the block width, and H denotes the block height):

$$\begin{matrix}i . & \\ W < T 1 , or , W <= T 1 & \end{matrix}$$

$$\begin{matrix}ii . & \\ H < T 2 , or , H <= T 2 & \end{matrix}$$

$$\begin{matrix}iii . & \\ Min ( W , H ) > T 3 , or , Min ( W , H ) > = T 3 & \end{matrix}$$

$$\begin{matrix}iv . & \\ Max ( W , H ) < T 4 , or , Max ( W , H ) <= T 4 & \end{matrix}$$

$$\begin{matrix}v . & \\ W < T 5 * H , or , W <= T 5 * H & \end{matrix}$$

$$\begin{matrix}vi . & \\ W > T 6 * H , or , W >= T 6 * H & \end{matrix}$$

$$\begin{matrix}vii . & \\ H < T 7 * W , or , H <= T 7 * W & \end{matrix}$$

$$\begin{matrix}viii . & \\ H > T 8 * W , or , H >= T 8 * W & \end{matrix}$$

$$\begin{matrix}ix . & \\ W * H < T 9 , or W * H <= T 9 & \end{matrix}$$

x. For example, T1, T2, . . . . T9 may be pre-defined integer constants.
e. For example, a CCRM mode may be allowed for small blocks only.
   i. For example, it may be allowed for blocks smaller than 4×4, or 8×8, or 16×16, or 32×32.
   ii. For example, it may be allowed for blocks with number of samples less than 32, or, 64, or 128.
   iii. For example, it may be allowed for blocks with number of samples less than 32, or, 64, or 128.
   iv. For example, it may not be allowed for 2×N blocks, wherein N may be greater than 4 or 8 or 16.
   v. For example, it may not be allowed for N×2 blocks, wherein N may be greater than 4 or 8 or 16.
23) The disclosed method may be used in single tree.
24) The disclosed method may be used in dual tree.
25) The disclosed method may be used in a inter (such as B or P) slice.
26) The disclosed method may be used in an intra (such as I) slice.
27) The “block vector” in the disclosed method may be a “motion vector”.
28) The training/reference sample in the disclosed method may refer to prediction sample and/or reconstruction sample in the training/reference area.
29) Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
30) Whether to and/or how to apply the disclosed methods above may be signalled at PB/TB/CB/PU/TU/CU/VPDU/CTU/CTU row/slice/tile/sub-picture/other kinds of region contain more than one sample or pixel.
31) Whether to and/or how to apply the disclosed methods above may be dependent on coded information, such as block size, colour format, single/dual tree partitioning, colour component, slice/picture type.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one or multiple CTUs/CTBs, one or multiple Virtual Pipeline Data Unit (VPDU), a sub-region within a picture/slice/tile/brick.

FIG. 30 illustrates a flowchart of a method 3000 for video processing in accordance with embodiments of the present disclosure. The method 3000 is implemented during a conversion between a video unit of a video and a bitstream of the video.

At block 3010, for a conversion between a video unit of a video and a bitstream of the video, it determines that one or more parameters of a cross-component residual model (CCRM) of the video unit is inherited from a previous CCRM coded block.

At block 3020, the conversion is performed based on the CCRM. In some embodiments, the conversion includes encoding the video unit into the bitstream. In some other embodiments, the conversion includes decoding the video unit from the bitstream. In this way, the estimated chroma prediction may be generated by adding a CCRM estimated residue block to the chroma prediction without CCRM, thereby improving coding efficiency and coding performance.

In some embodiments, at least one syntax element is signalled at a video unit level to specify whether and/or how to use CCRM model inheritance mode. For example, the at least one syntax element is signaled at one of: block level, transform unit (TU) level, prediction unit (PU) level, or coding unit (CU) level.

In some embodiments, an indicator to specify whether the video unit uses regular CCRM mode or CCRM model inheritance mode is signalled at video unit level. For example, the indicator to specify whether the video unit uses regular CCRM mode or CCRM model inheritance mode is signalled based on a condition associated with at least one type of CCRM used for the video unit.

In some embodiments, a first syntax is signalled to indicate that the video unit uses a type of CCRM mode, and a second syntax is further signalled to indicate that which type of CCRM mode is used. In some embodiments, the second syntax is signalled, if there is at least one available CCRM candidate.

In some embodiments, if CCRM model inheritance mode is used, another syntax is further signalled to specify which CCRM model candidate is selected to be inherited. In some other embodiments, an indicator is signalled at video unit level to specify at least one of: whether the video unit uses CCRM model inheritance mode or which candidate is used for CCRM model inheritance mode.

In some embodiments, if the CCRM model inheritance mode is used, a CCRM model candidate list is generated. In some embodiments, a maximum length of list size is pre-defined in the bitstream. For example, the list size is equal to 6 or 10 or 12.

In some embodiments, a size of history table is pre-defined. For example, the size of the history table is equal to 5 or 6.

In some embodiments, a CCRM model candidate is obtained based on previously coded CCRM blocks. In some embodiments, the previously coded CCRM blocks are at least one of: spatial adjacent neighbors, temporal candidate, spatial non-adjacent neighbors, history based CCRM candidate, shifted candidates, or default CCRM candidate.

In some embodiments, a candidate inserting order follows a pre-defined rule. For example, the candidate inserting order is a sequence as follows: spatial adjacent, temporal, spatial non-adjacent, history, shifted, default.

In some embodiments, a CCRM model candidate is checked at subblock granularity. In some embodiments, each continuous subblock within a pre-defined region is checked. For example, all 4×4 subblocks above and left to the video unit are checked. In some other embodiments, a pre-defined scatter check order is used for checking CCRM model candidates.

In some embodiments, positions of non-adjacent neighbor blocks are based on block dimensions of the video unit. For example, the positions are with a distance from the video unit, wherein the distance is proportional to a width and/or height of the video unit.

In some embodiments, a motion shift is used to locate temporal candidates. In some embodiments, the motion shift is based on a motion vector of a neighbor block. In some other embodiments, the temporal candidates are from a collocated picture. In some further embodiments, the temporal candidates are from a reference picture which is not a collocated picture.

In some embodiments, one or more history based CCRM candidates are from a first-in-first-out history table. For example, the first-in-first-out history table is initialized at one of: tile level, coding tree unit (CTU) level, row level, slice level, or picture level.

In some embodiments, at least one of pruning, redundancy, or similarity check is applied to CCRM candidate list construction. For example, if a to-be-inserted candidate is different from specified candidates already in a CCRM candidate list, the to-be-inserted candidate is inserted to the CCRM candidate list. In some embodiments, the specified candidates refer to all available CCRM candidates in the CCRM candidate list. In some other embodiments, the specified candidates refer to one or more CCRM candidates in the CCRM candidate list. For example, the one or more CCRM candidates comprise at least one of: a last CCRM candidate in the CCRM candidate list or last X CCRM candidates in the CCRM candidate list, where X is a pre-defined constant.

In some embodiments, at least one of: same pruning, same redundancy or same similarity check rule is applied to all types of CCRM candidates. In some other embodiments, at least one of: different pruning, different redundancy or different similarity check rules is applied to different types of CCRM candidates.

In some embodiments, a CCRM candidate reordering is applied to the CCRM model candidate list. In some embodiments, CCRM candidates in the CCRM model candidate list are sorted based on a decoder derived cost. In some other embodiments, a cost is derived based on applying the CCRM candidate to a reference region or reference block of the video unit. For example, the reference region or reference block is identified by a motion vector of a current block. In some embodiments, for each CCRM candidate, a CCRM model is firstly applied to a reference luma to get a predicted reference chroma, and then the cost is computed as an absolute difference between a true reference chroma and the predicted reference chroma.

In some embodiments, a cost is derived based on applying a CCRM candidate to a neighboring region or neighboring block of the video unit. In some embodiments, the neighboring region or neighboring block is above neighbors of the video unit or left neighbors of the video unit. In some other embodiments, for each CCRM candidate, a CCRM model is firstly applied to a neighboring luma to get a predicted neighboring chroma, and then the cost is computed as an absolute difference between a true neighboring chroma and the predicted neighboring chroma. In some embodiments, based on decoder derived costs. CCRM model candidates are sorted from lowest cost to highest cost, and a CCRM model candidate with minimum cost is ordered at the first of the CCRM model candidate list.

In some embodiments, if CCRM model inheritance mode is used, a target CCRM candidate model is directly applied to the video unit without model estimation. For example, a first candidate of the CCRM model candidate list is used for the CCRM model inheritance mode. In some other embodiments, which candidate of the CCRM model candidate list used to a block which is CCRM model inheritance mode coded is signalled in the bitstream.

In some embodiments, for a reconstructed reordered intra block copy (RRIBC) block coded with the CCRM mode inheritance mode, an inherited CCRM model is applied based on an inherited RRIBC flip type. For example, if the inherited RRIBC flip type indicates that the inherited CCRM model is from a RRIBC coded block, one or more CCRM filter taps for the video unit are flipped according to the inherited RRIBC flip type. In some embodiments, the inherited RRIBC flip type is non-zero. In some embodiments, during generating the CCRM filter taps from non-downsampled luma samples, filter taps of non-downsampled luma samples are swapped or flipped.

In some embodiments, if an 8-tap CCRM model comprises 6 spatial luma samples, a nonlinear term, and a bias term, spatial luma samples are obtained from a luma grid selecting 6 luma samples closest to a chroma position without down sampling, and a predicted chroma value is obtained as predChromaVal=c0L0+c1L1+c2L2+c3L3+c4L4+c5L5+c6 nonlinear((L0+L3+1)>>1)+c7 B. In this case, L0, L1, L2, L3, L4 and L5 represent spatial luma samples, respectively, c0, c1, c2, c3, c4, c5, c6 and c7 represent coefficients, respectively, nonlinear represents CCCM's nonlinear operator and B represents a bias.

In some embodiments, if the inherited CCRM model is from a horizontal flipped RRIBC coded block, during applying the inherited CCRM model to the video unit, luma samples L1 and L2 are swapped and luma samples L4 and L5 are swapped. In some other embodiments, if the inherited CCRM model is from a vertical flipped RRIBC coded block, during applying the inherited CCRM model to the video unit, luma samples L1 and L4 are swapped, luma samples L0 and L3 are swapped, and luma samples L2 and L5 are swapped.

In some embodiments, a CCRM model of a CCRM coded block is stored in a buffer. For example, stored CCRM model information includes at least one of the following information: CCRM model coefficients or taps or parameters of Cb and Cr components, respectively, middle value of the CCRM coded block, bit depth of the CCRM coded block, an offset value of Y component of the CCRM coded block, an offset values of U and/or V components of the CCRM coded block, or a RRIBC flip type of the CCRM coded block.

In some embodiments, the CCRM model inheritance mode is used in at least one of: single tree or dual tree. In some embodiments, the CCRM model inheritance mode is used in an inter slice. For example, the inter slice is a B slice or a P slice.

In some embodiments, the CCRM model inheritance mode is used in an intra slice. For example, the intra slice is an I slice.

In some embodiments, a training or a reference sample is a prediction sample in a training or reference area. In some other embodiments, a training or a reference sample is a reconstruction sample in a training or reference area.

In some embodiments, an indication of whether to and/or how to determine that one or more parameters of CCRM of the video unit is inherited from the previous CCRM coded block is indicated at one of the followings: sequence level, group of pictures level, picture level, slice level, or tile group level.

In some other embodiments, an indication of whether to and/or how to determine that one or more parameters of CCRM of the video unit is inherited from the previous CCRM coded block is indicated in one of the followings: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header. In some further embodiments, an indication of whether to and/or how to determine that one or more parameters of CCRM of the video unit is inherited from the previous CCRM coded block is included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 3000 further comprises: determining, based on coded information of the target block, whether to and/or how to that one or more parameters of CCRM of the video unit is inherited from the previous CCRM coded block, the coded information including at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining that one or more parameters of a cross-component residual model (CCRM) of a video unit of the video is inherited from a previous CCRM coded block; and generating the bitstream of the video unit based on the CCRM.

According to still further embodiments of the present disclosure, a method for storing bitstream of a video is provided. The method comprises: determining that one or more parameters of a cross-component residual model (CCRM) of a video unit of the video is inherited from a previous CCRM coded block: generating the bitstream of the video unit based on the CCRM; and storing the bitstream in a non-transitory computer-readable recording medium.

Implementations of the present disclosure can be described in view of the following clauses, the features of which can be combined in any reasonable manner.
Clause 1. A method for video processing, comprising: determining, for a conversion between a video unit of a video and a bitstream of the video, that one or more parameters of a cross-component residual model (CCRM) of the video unit is inherited from a previous CCRM coded block; and performing the conversion based on the CCRM.
Clause 2. The method of clause 1, wherein at least one syntax element is signalled at a video unit level to specify whether and/or how to use CCRM model inheritance mode.
Clause 3. The method of clause 2, wherein the at least one syntax element is signaled at one of: block level, transform unit (TU) level, prediction unit (PU) level, or coding unit (CU) level.
Clause 4. The method of clause 2, wherein an indicator to specify whether the video unit uses regular CCRM mode or CCRM model inheritance mode is signalled at video unit level.
Clause 5. The method of clause 2, wherein the indicator to specify whether the video unit uses regular CCRM mode or CCRM model inheritance mode is signalled based on a condition associated with at least one type of CCRM used for the video unit.
Clause 6. The method of clause 2, wherein a first syntax is signalled to indicate that the video unit uses a type of CCRM mode, and a second syntax is further signalled to indicate that which type of CCRM mode is used.
Clause 7. The method of clause 6, wherein the second syntax is signalled, if there is at least one available CCRM candidate.
Clause 8. The method of clause 2, wherein if CCRM model inheritance mode is used, another syntax is further signalled to specify which CCRM model candidate is selected to be inherited.
Clause 9. The method of clause 2, wherein an indicator is signalled at video unit level to specify at least one of: whether the video unit uses CCRM model inheritance mode or which candidate is used for CCRM model inheritance mode.
Clause 10. The method of clause 1, wherein if the CCRM model inheritance mode is used, a CCRM model candidate list is generated.
Clause 11. The method of clause 10, wherein a maximum length of list size is pre-defined in the bitstream.
Clause 12. The method of clause 11, wherein the list size is equal to 6 or 10 or 12.
Clause 13. The method of clause 11, wherein a size of history table is pre-defined.
Clause 14. The method of clause 13, wherein the size of the history table is equal to 5 or 6.
Clause 15. The method of clause 10, wherein a CCRM model candidate is obtained based on previously coded CCRM blocks.
Clause 16. The method of clause 15, wherein the previously coded CCRM blocks are at least one of: spatial adjacent neighbors, temporal candidate, spatial non-adjacent neighbors, history based CCRM candidate, shifted candidates, or default CCRM candidate.
Clause 17. The method of clause 15, wherein a candidate inserting order follows a pre-defined rule.
Clause 18. The method of clause 17, wherein the candidate inserting order is a sequence as follows: spatial adjacent, temporal, spatial non-adjacent, history, shifted, default.
Clause 19. The method of clause 15, wherein a CCRM model candidate is checked at subblock granularity.
Clause 20. The method of clause 19, wherein each continuous subblock within a pre-defined region is checked.
Clause 21. The method of clause 20, wherein all 4×4 subblocks above and left to the video unit are checked.
Clause 22. The method of clause 15, wherein a pre-defined scatter check order is used for checking CCRM model candidates.
Clause 23. The method of clause 15, wherein positions of non-adjacent neighbor blocks are based on block dimensions of the video unit.
Clause 24. The method of clause 23, wherein the positions are with a distance from the video unit, wherein the distance is proportional to a width and/or height of the video unit.
Clause 25. The method of clause 15, wherein a motion shift is used to locate temporal candidates.
Clause 26. The method of clause 25, wherein the motion shift is based on a motion vector of a neighbor block.
Clause 27. The method of clause 25, wherein the temporal candidates are from a collocated picture.
Clause 28. The method of clause 25, wherein the temporal candidates are from a reference picture which is not a collocated picture.
Clause 29. The method of clause 15, wherein one or more history based CCRM candidates are from a first-in-first-out history table.
Clause 30. The method of clause 29, wherein the first-in-first-out history table is initialized at one of: tile level, coding tree unit (CTU) level, row level, slice level, or picture level.
Clause 31. The method of clause 10, wherein at least one of pruning, redundancy, or similarity check is applied to CCRM candidate list construction.
Clause 32. The method of clause 31, wherein if a to-be-inserted candidate is different from specified candidates already in a CCRM candidate list, the to-be-inserted candidate is inserted to the CCRM candidate list.
Clause 33. The method of clause 32, wherein the specified candidates refer to all available CCRM candidates in the CCRM candidate list.
Clause 34. The method of clause 32, wherein the specified candidates refer to one or more CCRM candidates in the CCRM candidate list.
Clause 35. The method of clause 34, wherein the one or more CCRM candidates comprise at least one of: a last CCRM candidate in the CCRM candidate list or last X CCRM candidates in the CCRM candidate list, wherein X is a pre-defined constant.
Clause 36. The method of clause 31, wherein at least one of: same pruning, same redundancy or same similarity check rule is applied to all types of CCRM candidates.
Clause 37. The method of clause 31, wherein at least one of: different pruning, different redundancy or different similarity check rules is applied to different types of CCRM candidates.
Clause 38. The method of clause 10, wherein a CCRM candidate reordering is applied to the CCRM model candidate list.
Clause 39. The method of clause 38, wherein CCRM candidates in the CCRM model candidate list are sorted based on a decoder derived cost.
Clause 40. The method of clause 38, wherein a cost is derived based on applying the CCRM candidate to a reference region or reference block of the video unit.
Clause 41. The method of clause 40, wherein the reference region or reference block is identified by a motion vector of a current block.
Clause 42. The method of clause 40, wherein for each CCRM candidate, a CCRM model is firstly applied to a reference luma to get a predicted reference chroma, and then the cost is computed as an absolute difference between a true reference chroma and the predicted reference chroma.
Clause 43. The method of clause 38, wherein a cost is derived based on applying a CCRM candidate to a neighboring region or neighboring block of the video unit.
Clause 44. The method of clause 43, wherein the neighboring region or neighboring block is above neighbors of the video unit or left neighbors of the video unit.
Clause 45. The method of clause 43, wherein for each CCRM candidate, a CCRM model is firstly applied to a neighboring luma to get a predicted neighboring chroma, and then the cost is computed as an absolute difference between a true neighboring chroma and the predicted neighboring chroma.
Clause 46. The method of clause 38, wherein based on decoder derived costs, CCRM model candidates are sorted from lowest cost to highest cost, and a CCRM model candidate with minimum cost is ordered at the first of the CCRM model candidate list.
Clause 47. The method of clause 1, wherein if CCRM model inheritance mode is used, a target CCRM candidate model is directly applied to the video unit without model estimation.
Clause 48. The method of clause 47, wherein a first candidate of the CCRM model candidate list is used for the CCRM model inheritance mode.
Clause 49. The method of clause 47, wherein which candidate of the CCRM model candidate list used to a block which is CCRM model inheritance mode coded is signalled in the bitstream.
Clause 50. The method of clause 47, wherein for a reconstructed reordered intra block copy (RRIBC) block coded with the CCRM mode inheritance mode, an inherited CCRM model is applied based on an inherited RRIBC flip type.
Clause 51. The method of clause 50, wherein if the inherited RRIBC flip type indicates that the inherited CCRM model is from a RRIBC coded block, one or more CCRM filter taps for the video unit are flipped according to the inherited RRIBC flip type.
Clause 52. The method of clause 51, wherein the inherited RRIBC flip type is non-zero.
Clause 53. The method of clause 51, wherein during generating the CCRM filter taps from non-downsampled luma samples, filter taps of non-downsampled luma samples are swapped or flipped.
Clause 54. The method of clause 50, wherein if an 8-tap CCRM model comprises 6 spatial luma samples, a nonlinear term, and a bias term, spatial luma samples are obtained from a luma grid selecting 6 luma samples closest to a chroma position without down sampling, and a predicted chroma value is obtained as predChromaVal=c0 L0+c1L1+c2L2+c3L3+c4L4+c5L5+c6 nonlinear((L0+L3+1)>>1)+c7 B, wherein L0, L1, L2, L3, L4 and L5 represent spatial luma samples, respectively, c0, c1, c2, c3, c4, c5, c6 and c7 represent coefficients, respectively, nonlinear represents CCCM's nonlinear operator and B represents a bias.
Clause 55. The method of clause 54, wherein if the inherited CCRM model is from a horizontal flipped RRIBC coded block, during applying the inherited CCRM model to the video unit, luma samples L1 and L2 are swapped and luma samples L4 and L5 are swapped.
Clause 56. The method of clause 54, wherein if the inherited CCRM model is from a vertical flipped RRIBC coded block, during applying the inherited CCRM model to the video unit, luma samples L1 and L4 are swapped, luma samples L0 and L3 are swapped, and luma samples L2 and L5 are swapped.
Clause 57. The method of clause 1, wherein a CCRM model of a CCRM coded block is stored in a buffer.
Clause 58. The method of clause 57, wherein stored CCRM model information includes at least one of the following information: CCRM model coefficients or taps or parameters of Cb and Cr components, respectively, middle value of the CCRM coded block, bit depth of the CCRM coded block, an offset value of Y component of the CCRM coded block, an offset values of U and/or V components of the CCRM coded block, or a RRIBC flip type of the CCRM coded block.
Clause 59. The method of clause 1, wherein the CCRM model inheritance mode is used in at least one of: single tree or dual tree.
Clause 60. The method of clause 1, wherein the CCRM model inheritance mode is used in an inter slice.
Clause 61. The method of clause 60, wherein the inter slice is a B slice or a P slice.
Clause 62. The method of clause 1, wherein the CCRM model inheritance mode is used in an intra slice.
Clause 63. The method of clause 62, wherein the intra slice is an I slice.
Clause 64. The method of clause 1, wherein a training or a reference sample is a prediction sample in a training or reference area.
Clause 65. The method of clause 1, wherein a training or a reference sample is a reconstruction sample in a training or reference area.
Clause 66. The method of any of clauses 1-62, wherein an indication of whether to and/or how to determine that one or more parameters of CCRM of the video unit is inherited from the previous CCRM coded block is indicated at one of the followings: sequence level, group of pictures level, picture level, slice level, or tile group level.
Clause 67. The method of any of clauses 1-62, wherein an indication of whether to and/or how to determine that one or more parameters of CCRM of the video unit is inherited from the previous CCRM coded block is indicated in one of the followings: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header.
Clause 68. The method of any of clauses 1-62, wherein an indication of whether to and/or how to determine that one or more parameters of CCRM of the video unit is inherited from the previous CCRM coded block is included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.
Clause 69. The method of any of clauses 1-62, further comprising: determining, based on coded information of the target block, whether to and/or how to that one or more parameters of CCRM of the video unit is inherited from the previous CCRM coded block, the coded information including at least one of: a block size, a colour format, a single and/or dual tree partitioning, a colour component, a slice type, or a picture type.
Clause 70. The method of any of clauses 1-69, wherein the conversion includes encoding the video unit into the bitstream.
Clause 71. The method of any of clauses 1-69, wherein the conversion includes decoding the video unit from the bitstream.
Clause 72. An apparatus for video processing comprising a processor and a non-transitory memory with instructions thereon, wherein the instructions upon execution by the processor, cause the processor to perform a method in accordance with any of clauses 1-71.
Clause 73. A non-transitory computer-readable storage medium storing instructions that cause a processor to perform a method in accordance with any of clauses 1-71.
Clause 74. A non-transitory computer-readable recording medium storing a bitstream of a video which is generated by a method performed by an apparatus for video processing, wherein the method comprises: determining that one or more parameters of a cross-component residual model (CCRM) of a video unit of the video is inherited from a previous CCRM coded block; and generating the bitstream of the video unit based on the CCRM.
Clause 75. A method for storing a bitstream of a video, comprising: determining that one or more parameters of a cross-component residual model (CCRM) of a video unit of the video is inherited from a previous CCRM coded block: generating the bitstream of the video unit based on the CCRM; and storing the bitstream in a non-transitory computer-readable recording medium.

### Example Device

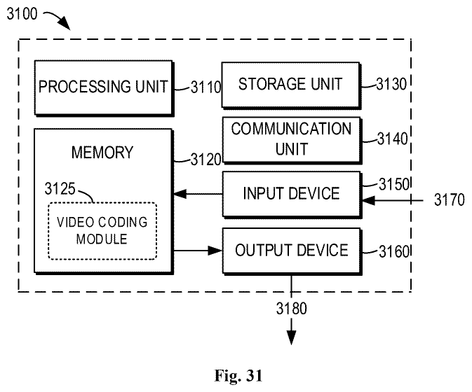

FIG. 31 illustrates a block diagram of a computing device 3100 in which various embodiments of the present disclosure can be implemented. The computing device 3100 may be implemented as or included in the source device 110 (or the video encoder 114 or 200) or the destination device 120 (or the video decoder 124 or 300).

It would be appreciated that the computing device 3100 shown in FIG. 31 is merely for purpose of illustration, without suggesting any limitation to the functions and scopes of the embodiments of the present disclosure in any manner.

As shown in FIG. 31, the computing device 3100 includes a general-purpose computing device 3100. The computing device 3100 may at least comprise one or more processors or processing units 3110, a memory 3120, a storage unit 3130, one or more communication units 3140, one or more input devices 3150, and one or more output devices 3160.

In some embodiments, the computing device 3100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3100 can support any type of interface to a user (such as “wearable” circuitry and the like).

The processing unit 3110 may be a physical or virtual processor and can implement various processes based on programs stored in the memory 3120. In a multi-processor system, multiple processing units execute computer executable instructions in parallel so as to improve the parallel processing capability of the computing device 3100. The processing unit 3110 may also be referred to as a central processing unit (CPU), a microprocessor, a controller or a microcontroller.

The computing device 3100 typically includes various computer storage medium. Such medium can be any medium accessible by the computing device 3100, including, but not limited to, volatile and non-volatile medium, or detachable and non-detachable medium. The memory 3120 can be a volatile memory (for example, a register, cache, Random Access Memory (RAM)), a non-volatile memory (such as a Read-Only Memory (ROM). Electrically Erasable Programmable Read-Only Memory (EEPROM), or a flash memory), or any combination thereof. The storage unit 3130 may be any detachable or non-detachable medium and may include a machine-readable medium such as a memory, flash memory drive, magnetic disk or another other media, which can be used for storing information and/or data and can be accessed in the computing device 3100.

The computing device 3100 may further include additional detachable/non-detachable, volatile/non-volatile memory medium. Although not shown in FIG. 31, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3140 communicates with a further computing device via the communication medium. In addition, the functions of the components in the computing device 3100 can be implemented by a single computing cluster or multiple computing machines that can communicate via communication connections. Therefore, the computing device 3100 can operate in a networked environment using a logical connection with one or more other servers, networked personal computers (PCs) or further general network nodes.

The input device 3150 may be one or more of a variety of input devices, such as a mouse, keyboard, tracking ball, voice-input device, and the like. The output device 3160 may be one or more of a variety of output devices, such as a display, loudspeaker, printer, and the like. By means of the communication unit 3140, the computing device 3100 can further communicate with one or more external devices (not shown) such as the storage devices and display device, with one or more devices enabling the user to interact with the computing device 3100, or any devices (such as a network card, a modem and the like) enabling the computing device 3100 to communicate with one or more other computing devices, if required. Such communication can be performed via input/output (I/O) interfaces (not shown).

In some embodiments, instead of being integrated in a single device, some or all components of the computing device 3100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3100 may be used to implement video encoding/decoding in embodiments of the present disclosure. The memory 3120 may include one or more video coding modules 3125 having one or more program instructions. These modules are accessible and executable by the processing unit 3110 to perform the functionalities of the various embodiments described herein.

In the example embodiments of performing video encoding, the input device 3150 may receive video data as an input 3170 to be encoded. The video data may be processed, for example, by the video coding module 3125, to generate an encoded bitstream. The encoded bitstream may be provided via the output device 3160 as an output 3180.

In the example embodiments of performing video decoding, the input device 3150 may receive an encoded bitstream as the input 3170. The encoded bitstream may be processed, for example, by the video coding module 3125, to generate decoded video data. The decoded video data may be provided via the output device 3160 as the output 3180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method for video processing, comprising:
determining, for a conversion between a video unit of a video and a bitstream of the video, that one or more parameters of a cross-component residual model (CCRM) of the video unit is inherited from a previous CCRM coded block; and
performing the conversion based on the CCRM.

2. The method of claim 1, wherein at least one syntax element is signalled at a video unit level to specify whether and/or how to use CCRM model inheritance mode.

3. The method of claim 2, wherein the at least one syntax element is signaled at one of: block level, transform unit (TU) level, prediction unit (PU) level, or coding unit (CU) level, and/or
wherein an indicator to specify whether the video unit uses regular CCRM mode or CCRM model inheritance mode is signalled at video unit level, and/or
wherein the indicator to specify whether the video unit uses regular CCRM mode or CCRM model inheritance mode is signalled based on a condition associated with at least one type of CCRM used for the video unit, and/or
wherein a first syntax is signalled to indicate that the video unit uses a type of CCRM mode, and a second syntax is further signalled to indicate that which type of CCRM mode is used, and/or
wherein if CCRM model inheritance mode is used, another syntax is further signalled to specify which CCRM model candidate is selected to be inherited, and/or
wherein an indicator is signalled at video unit level to specify at least one of: whether the video unit uses CCRM model inheritance mode or which candidate is used for CCRM model inheritance mode.

4. The method of claim 3, wherein the second syntax is signalled, if there is at least one available CCRM candidate.

5. The method of claim 1, wherein if the CCRM model inheritance mode is used, a CCRM model candidate list is generated.

6. The method of claim 5, wherein a maximum length of list size is pre-defined in the bitstream, and/or
wherein a CCRM model candidate is obtained based on previously coded CCRM blocks, and/or
wherein at least one of pruning, redundancy, or similarity check is applied to CCRM candidate list construction, and/or
wherein a CCRM candidate reordering is applied to the CCRM model candidate list.

7. The method of claim 6, wherein the list size is equal to 6 or 10 or 12, and/or
wherein a size of history table is pre-defined, and/or
wherein the previously coded CCRM blocks are at least one of: spatial adjacent neighbors, temporal candidate, spatial non-adjacent neighbors, history based CCRM candidate, shifted candidates, or default CCRM candidate, and/or
wherein a candidate inserting order follows a pre-defined rule, and/or
wherein a CCRM model candidate is checked at subblock granularity, and/or
wherein a pre-defined scatter check order is used for checking CCRM model candidates, and/or
wherein positions of non-adjacent neighbor blocks are based on block dimensions of the video unit, and/or
wherein a motion shift is used to locate temporal candidates, and/or
wherein one or more history based CCRM candidates are from a first-in-first-out history table, and/or
wherein if a to-be-inserted candidate is different from specified candidates already in a CCRM candidate list, the to-be-inserted candidate is inserted to the CCRM candidate list, and/or
wherein at least one of: same pruning, same redundancy or same similarity check rule is applied to all types of CCRM candidates, and/or
wherein at least one of: different pruning, different redundancy or different similarity check rules is applied to different types of CCRM candidates, and/or
wherein CCRM candidates in the CCRM model candidate list are sorted based on a decoder derived cost, and/or
wherein a cost is derived based on applying the CCRM candidate to a reference region or reference block of the video unit, and/or
wherein a cost is derived based on applying a CCRM candidate to a neighboring region or neighboring block of the video unit, and/or
wherein based on decoder derived costs, CCRM model candidates are sorted from lowest cost to highest cost, and a CCRM model candidate with minimum cost is ordered at the first of the CCRM model candidate list.

8. The method of claim 7, wherein the size of the history table is equal to 5 or 6, and/or
wherein the candidate inserting order is a sequence as follows: spatial adjacent, temporal, spatial non-adjacent, history, shifted, default, and/or
wherein each continuous subblock within a pre-defined region is checked, and/or
wherein the positions are with a distance from the video unit, wherein the distance is proportional to a width and/or height of the video unit, and/or
wherein the motion shift is based on a motion vector of a neighbor block, and/or
wherein the temporal candidates are from a collocated picture, and/or
wherein the temporal candidates are from a reference picture which is not a collocated picture, and/or
wherein the first-in-first-out history table is initialized at one of: tile level, coding tree unit (CTU) level, row level, slice level, or picture level, and/or
wherein the specified candidates refer to all available CCRM candidates in the CCRM candidate list, and/or
wherein the specified candidates refer to one or more CCRM candidates in the CCRM candidate list, and/or
wherein the reference region or reference block is identified by a motion vector of a current block, and/or
wherein for each CCRM candidate, a CCRM model is firstly applied to a reference luma to get a predicted reference chroma, and then the cost is computed as an absolute difference between a true reference chroma and the predicted reference chroma, and/or
wherein the neighboring region or neighboring block is above neighbors of the video unit or left neighbors of the video unit, and/or
wherein for each CCRM candidate, a CCRM model is firstly applied to a neighboring luma to get a predicted neighboring chroma, and then the cost is computed as an absolute difference between a true neighboring chroma and the predicted neighboring chroma.

9. The method of claim 8, wherein all 4×4 subblocks above and left to the video unit are checked, and/or
wherein the one or more CCRM candidates comprise at least one of: a last CCRM candidate in the CCRM candidate list or last X CCRM candidates in the CCRM candidate list, wherein X is a pre-defined constant.

10. The method of claim 1, wherein if CCRM model inheritance mode is used, a target CCRM candidate model is directly applied to the video unit without model estimation, and/or
wherein a CCRM model of a CCRM coded block is stored in a buffer.

11. The method of claim 10, wherein a first candidate of the CCRM model candidate list is used for the CCRM model inheritance mode, and/or
wherein which candidate of the CCRM model candidate list used to a block which is CCRM model inheritance mode coded is signalled in the bitstream, and/or
wherein for a reconstructed reordered intra block copy (RRIBC) block coded with the CCRM mode inheritance mode, an inherited CCRM model is applied based on an inherited RRIBC flip type.

12. The method of claim 11, wherein if the inherited RRIBC flip type indicates that the inherited CCRM model is from a RRIBC coded block, one or more CCRM filter taps for the video unit are flipped according to the inherited RRIBC flip type.

13. The method of claim 12, wherein the inherited RRIBC flip type is non-zero, and/or
wherein during generating the CCRM filter taps from non-downsampled luma samples, filter taps of non-downsampled luma samples are swapped or flipped.

14. The method of claim 11, wherein if an 8-tap CCRM model comprises 6 spatial luma samples, a nonlinear term, and a bias term, spatial luma samples are obtained from a luma grid selecting 6 luma samples closest to a chroma position without down sampling, and a predicted chroma value is obtained as predChromaVal=c0 L0+c1L1+c2L2+c3L3+c4L4+c5L5+c6 nonlinear((L0+L3+1)>>1)+c7 B, wherein L0, L1, L2, L3, L4 and L5 represent spatial luma samples, respectively, c0, c1, c2, c3, c4, c5, c6 and c7 represent coefficients, respectively, nonlinear represents CCCM's nonlinear operator and B represents a bias.

15. The method of claim 14, wherein if the inherited CCRM model is from a horizontal flipped RRIBC coded block, during applying the inherited CCRM model to the video unit, luma samples L1 and L2 are swapped and luma samples L4 and L5 are swapped, and/or
wherein if the inherited CCRM model is from a vertical flipped RRIBC coded block, during applying the inherited CCRM model to the video unit, luma samples L1 and L4 are swapped, luma samples L0 and L3 are swapped, and luma samples L2 and L5 are swapped.

16. The method of claim 10, wherein stored CCRM model information includes at least one of the following information:
CCRM model coefficients or taps or parameters of Cb and Cr components, respectively,
middle value of the CCRM coded block,
bit depth of the CCRM coded block,
an offset value of Y component of the CCRM coded block,
an offset values of U and/or V components of the CCRM coded block, or
a RRIBC flip type of the CCRM coded block.

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to perform acts comprising:
determining, for a conversion between a video unit of a video and a bitstream of the video, that one or more parameters of a cross-component residual model (CCRM) of the video unit is inherited from a previous CCRM coded block; and
performing the conversion based on the CCRM.

19. A non-transitory computer-readable storage medium storing instructions that cause a processor to perform acts comprising:
determining, for a conversion between a video unit of a video and a bitstream of the video, that one or more parameters of a cross-component residual model (CCRM) of the video unit is inherited from a previous CCRM coded block; and
performing the conversion based on the CCRM.

20. A non-transitory computer-readable recording medium storing a bitstream of a video which is generated by a method performed by an apparatus for video processing, wherein the method comprises:
determining that one or more parameters of a cross-component residual model (CCRM) of a video unit of the video is inherited from a previous CCRM coded block; and
generating the bitstream of the video unit based on the CCRM.
